(19) United States
(12) Patent Application Publication
(10) Pub. No.: US 2003/0033191 A1
(43) Pub. Date: Feb. 13, 2003

(54) Method and apparatus for a product lifecycle management process

(75) Inventors: James Davies, Alameda, CA (US); Paul Chabot, San Francisco, CA (US); Mark Rubin, Ben Lomand, CA (US)

Correspondence Address: QUINE INTELLECTUAL PROPERTY LAW GROUP, P.C., P O BOX 458, ALAMEDA, CA, 94501, US

(73) Assignee: XIS Incorporated, San Francisco, CA (US)

(21) Appl. No.: 09/883,094

(22) Filed: Jun. 15, 2001

Related U.S. Application Data
(60) Provisional application No. 60/211,818, filed on Jun. 15, 2000.
(60) Provisional application No. 60/281,061, filed on Apr. 2, 2001.

(51) Int. Cl. G06F 17/60

(52) U.S. Cl. 705/10

(57) ABSTRACT

Techniques, methods, systems and system components facilitate new product development and product lifecycle management in an enterprise. According to a specific embodiment, the invention provides a networked-enabled development software engine that assists users coordinate and keep track of progress and status of development activities. A unifying structure for Business Objects allows the software engine to provide a number of integrated cross-program functions, such as portfolio review and automated resource assignment and allows object portability and allows new objects to be more easily created from old objects.

### CROSS REFERENCE TO RELATED APPLICATIONS

This application claims benefit of priority from provisional patent application No. 60/211,818, filed Jun. 15, 2000, all parts of which are incorporated herein by reference.

This application claims benefit of priority from provisional patent application No. 60/281,016, filed Apr. 2, 2001, all parts of which are incorporated herein by reference.

### COPYRIGHT NOTICE

This application includes materials for which is claimed copyright protection (such as, but not limited to, source code listings, screen shots, user interfaces, or user instructions, or any other aspects of this submission for which copyright protection is or may be available in any jurisdiction.) Permission is hereby granted to make copies of this application and parts thereof solely in connection with the making of facsimile copies of this patent document in accordance with applicable law; all other rights are reserved, and all other reproduction, distribution, creation of derivative works based on the contents, public display, and public performance of the application or any part thereof are prohibited by applicable copyright law.

### FIELD OF THE INVENTION

The present invention relates to the field of information systems. In specific embodiments, the present invention is directed to methods and/or systems and/or devices for automating and/or assisting various aspects of lifecycle management of products, processes, or services.

### BACKGROUND OF THE INVENTION

New Product Development (NPD) and Product Lifecycle Management (PLM) are among the most complex of business processes. Among the many challenges to these processes are the pressure to reduce time to market, while still guaranteeing product quality. These processes involve complex project teams (often distributed throughout an enterprise and across organizational boundaries). These process also present a need to establish an appropriate level of management control that however does not inhibit what is often a highly creative process. NPD/PLM is that part of the product or process lifecycle that defines how new products are selected, designed, developed, tested, and released to manufacturing. NPD/PLM processes exist to ensure that new products are developed in a controlled environment so as to ensure their quality and a minimum of surprise. The latter goal is intended to drive the design process in a manner such that a product's manufacturability is ensured, and a minimum of rework and cost is achieved. NPD and PLM concepts will be further understood from the material provided herein.

NPD Theories/Approaches: IPD/IPPD, IEEE, PMI, etc.:

Integrated Product Development (IPD), or Integrated Product and Process Development (IPPD), is an approach to NPD that stresses the need for integration of organizations across functional boundaries and focuses on the development of products in an integrated, team-based environment. This approach is widely implemented in the Aerospace and Defense Industries and is often required of government programs. At the core of this approach is the Integrated Product Team (IPT): a cross-functional team formed for the expressed purpose of delivering a product to an external or internal customer. IPTs are created to support various levels, or tiers, of a project or program as defined by a product's breakdown structure. At the highest level, the First-Tier IPT represents the system level and is responsible for the breakdown of the product into its various sub-products or sub-elements. Each sub-element of the product is then the responsibility of a Sub-Tier IPT. The IPD approach allows the benefit of cross-functional collaboration. This is accomplished by means of breaking a product down into more manageable pieces while incorporating a mechanism for maintaining higher level control and visibility.

Organizations such as the IEEE and PMI have advanced other, similar approaches to the NPD/PLM process. Some of these approaches stress the inter-relationships and interdependencies of critical NPD/PLM processes and the products of those processes.

Assessment Models-SEI CMM and ISO 9000:

Developed at Carnegie Melon's Software Engineering Institute (SEI), the SEI Capability Maturity Model (CMM) defines five levels of software process maturity for aspiring organizations to achieve. From simply producing a product, to exhibiting a strong control of the development process as well as a proactive approach to continuous improvement, the various levels define those organizational and process-related activities necessary to mature software development practices. Like the SEI CMM, ISO 9000 provides guidelines for organizations and a scheme for assessment. Unlike the SEI CMM, ISO 9000 does not limit itself to the development of software, rather it focuses on all functions and processes in an organization (save but a few) without regard to industry or product.

Decision Gates:

The Decision Gates concept formalizes the understood reality that some steps in a given process must be completed before other steps can begin. While this is well understood, a number of issues are commonly left out of decision gate review processes.

Various methods exist for implementing NPD Methodologies. Among them, paper documentation and management edict are widely used. However, there also exists technological alternatives to managing various aspects of business processes.

Workflow, Electronic Document Management (EDM), and Product Data Management (PDM) tools have become increasingly powerful and popular. The proliferation of Corporate Intranet development as well as the advent of Knowledge and Program Management tools has become more evident as well. Tools such as Open Text's Livelink provide a medium for automating many activities, NPD related and otherwise, and embedding those defined process into an organization.

### SUMMARY

The present invention comprises, according to specific embodiments, techniques, methods, systems and/or system components that can assistant in new product development/product lifecycle management in an enterprise. According to a specific embodiment, the invention provides a networked-enabled development software engine that assists users and managers at all levels of an enterprise coordinate and keep track of progress and status of development activities. While a software engine according to the present invention allows appropriate users to perform a high level of customization of software objects to model a user's particular development process, the invention also imposes some unifying structure to all Business Objects. This unifying structure allows the software engine to provide a number of integrated cross-program functions, such as portfolio review and automated resource assignment. This unifying structure also allows object portability and allows new objects to be more easily created from old objects.

Business (or Methodology) Object Model

According to specific embodiments of the present invention, the invention provides related business objects that represent the components of a product development lifecycle (e.g. Methodology, Lifecycle, Role, Phase, Deliverable, Resource Assignment, seems new Fixed Cost, and Risk). Using these objects as building blocks, users can model any lifecycle, and then automate its execution via workflow.

Most prior applications store lifecycle information in an indented task hierarchy. The products Idweb (IDe) and Accelerate (MS2), for example, may have objects that use business rules and states to track what is being worked on and what is complete. A Business Object Model according to specific embodiments of the present invention is unique in that it is capable of enforcing process (how, when, and by whom things get done) and automating the execution of a program.

State-Based Workflow

According to specific embodiments of the present invention, business objects have states that characterize status (e.g. Pending, Planning, Active, Complete, Inactive, and Canceled). Objects are created in a state and can transition between states based on business rules. State transitions can be manual or automatic. Automatic state transitions occur based on similar transitions of other related objects. State-based workflow enables “just-in-time” task notification where tasks are linked to specific work products and work instructions.

Other prior applications use state to track the status of activities (ex: active or complete), but do not use them to enable cascading object state transitions that automate the development process. Other applications use lists of all present and future assignments that may or may not be ready to be worked on when the due date arrives. They are not able to support the concept of ‘just-in-time’ assignment that ensure all predecessors are complete prior to task notification.

Business Rule Dependent Object Behavior

How each business object behaves (what it can do at what time) depends on business rules. Objects can be nested to form a structure or hierarchy where the behavior of a business object can be based on: (1) Its contents. For example, a gate review cannot be complete until all the questionnaires are complete or a program cannot be completed until all its phases are complete. (2) Its own business rules. For example, lifecycle applicability rules determine what type of program they can be used on. (3) Its relationships with other objects. For example when a deliverable has a start to finish relationships with another, it cannot go active until the predecessor deliverable is complete. (4) Its parent object. For example a workflow process in a deliverable is automatically initiated when the deliverable becomes active. When a phase is activated the deliverables it contains are activated (depending on their relationships). Earlier programs, such as IDe and MS2, appear to only use the concept of states to track what is being worked on and what is complete. They do not use objects that have associated business rules and states that govern the object's unique behaviors.

Portfolio Object Model

According to specific embodiments of the present invention, the invention provides related business objects that are the components of a Program Portfolio Management System (e.g. Portfolio Review, Gate Review, Questionnaire, Metric and Factor). Using these objects as building blocks, users can create a customized measurement system whereby consistent and comparable information on the performance and attractiveness of products in a portfolio is gathered, analyzed and compared.

Most other systems involve manual entry of program data so it can be consolidated and graphed or analyzed. One system, IDe, has gone one step further—in that they have a fixed set of standard questions whose responses are used to calculate a single risk score and that risk score is one data point used in portfolio analysis. The present invention, in contrast, according to specific embodiments provides the following features:

Users define questions and answer scales.

Users define performance or attractiveness metrics

Users define how question scores are used to calculate metrics

Questionnaire are generated and sent to any number of users. The responses can then be gathered, discussed, and a consensus score for each question agreed on and that score is used to calculate metrics.

Any combination of metrics can be analyzed by rendering a table or bubble chart form.

Information Aggregation

According to specific embodiments of the present invention, as objects are added, removed, moved, and/or modified, schedule, costs and risk information is automatically recalculated, aggregated, and reported at all levels of the program hierarchy and at the portfolio level. This results in real-time accurate information for individual development programs and for the overall product portfolio.

Other prior applications keep track of plan information and rely on periodic user updates to see how they are performing to plan. IDe has gone further and offer real-time reporting but it has a rigid reporting structure that cannot adapt as easily to the unique program hierarchies.

Dynamic Scheduling/Living Schedule

According to specific embodiments of the present invention, when a change is made to a lifecycle that results in a change in its schedule (such as adding, removing, moving, and/or modifying objects), the schedule is automatically recalculated to ensure earliest completion date given the dependencies between lifecycle objects.

Unlike other applications where the program schedule (present and future) is static, according to specific embodiments the present invention always reflects the impact of changes, delays or acceleration in the development process. It is constantly evolving to adapt to changing development conditions and always presents the most efficient and realistic plan going forward. Naturally, all process automation also adapts to these changes. Status Indicators, Tolerances, and Overrides

According to specific embodiments, the present invention provides reporting of information for certain business objects. This reporting can include visual “traffic light” indicator of status. Colors of the indicator is determined by variance of Forecast to Plan values for schedule and cost. The degree of variance required to change status indicator color is determined by user-configured tolerance limits. Overrides to automatic status indicator colors can be manually set. While indicators that change color when certain tolerances are met are fairly common, most are retroactive and only notify users when things are out of control. According to specific embodiments, the present invention compares real-time forecast data to plan data, thereby generate a proactive notification that warns of potential cost overruns or delays.

Critical Path Escalation and Notification

According to specific embodiments, the present invention provides that notification of slips in schedule (via traffic light indicators) are only escalated to higher level reports if they occur along the critical path, supporting management by exception and ensuring development time is minimized. Therefore, if top-level traffic light is red, it means a critical path task has slipped. By clicking on the traffic light you can drill down through a series of reports until you find the task causing the problem. All other tasks not along the critical path can slip without triggering traffic lights, until they slip to the point they become part of the critical path. This feature is not provided in any other product of which the inventors are aware.

Environment Sensitivity of Business Objects

According to specific embodiments of the present invention, the behavior of lifecycle business objects is based on their environment. This means the same object can act as a generic building block/template, or as an active object found in a lifecycle used by a live program. This allows users to build generic lifecycles in a methodology that can then be copied into a program, at which point the behavior of these building blocks changes and they can support program planning, tracking, and automation.

In contrast, most prior applications store documents, schedule, and resource information in a folder structure. This information is used as a template for a program. According to specific embodiments of the present invention, templates (e.g. lifecycles) are more comprehensive in that they contain the business rules that determine how and when they are to be used and how they will behave when they are used. They are in fact complete programs that are ready to be activated when place in a program environment.

Process Enforcement

According to specific embodiments of the present invention, when designing generic lifecycles, an architect or manager can define what can be modified and what must remain unchanged when the lifecycles are applied to development programs. This limits what a program manager can do (delete, move or change the relationships of an element) thereby providing process consistency (what gets done when, how and by who) and ensuring best practices are followed. Further, users can create codes that classify these lifecycles and specify what type of programs they can be used on. This helps program managers select the most appropriate lifecycle when creating a program.

A Business Object Model according to specific embodiments of the present invention is unique in its ability to enforce process (how, when, and by who things get done) during the planning and execution of a program. Further, no other application facilitates the selection of an applicable subset of lifecycles based on criteria entered during program creation.

Gate Review Outcomes

According to specific embodiments of the present invention, Gate Reviews can have a number of outcomes (e.g. Pass, Conditional Pass, and Fail). In the case of Pass and Conditional Pass, options are provided to continue work in a subsequent phase. Selecting this option causes incomplete deliverables and resources to be replicated in another phase. Other applications support gate reviews using only checklists where users check off items that have been complete in the phase. According to specific embodiments of the present invention, the invention provides the only application known that facilitates the gate review process by:

Automating the polling of stakeholders using a customizable questionnaire;

Consolidating questionnaire results, status information and attractiveness measures for review;

Using the review outcome to drive state changes; and

Automating the transfer of incomplete deliverable to the next phase in the event of a conditional pass.

The invention will be better understood with reference to the following detailed descriptions, user documentation, and design specifications. In some of the detailed descriptions provided herein, the present invention is described in terms of the important independent embodiment of a comprehensive software product (Novare™) for facilitating NPD/PLM. This should not be taken to limit the invention, which, using the teachings provided herein, can be applied to other business data and development situations. It will be understood from the teachings herein to those of skill in the art that discussions of Novare™ examples provide just one example of the invention, which can be embodied in a variety of different systems.

Furthermore, it is well known in the art that logic systems can include a wide variety of different components and different functions in a modular fashion. Different embodiments of a system can include different mixtures of elements and functions and may group various functions as parts of various elements. For purposes of clarity, the invention is described in terms of systems that include many different innovative components and innovative combinations of components. No inference should be taken to limit the invention to combinations containing all of the innovative components listed in any illustrative embodiment in this specification. Thus, the present invention is herein described both in terms of general methods and devices and with respect to a specific product embodiment. It will be understood to those of skill in the art from the teachings provided herein that the described invention can be implemented in a wide variety of specific programming environments and logical systems (such as UNIX, Windows, Solaris, Oracle, etc.) using a wide variety of programming languages (such as SQL, Visual Basic, HTML, dHTML, Pascal, C++, Basic, Java, LiveLink, etc.) and wide variety of file fornats.

What follows are descriptions of example systems and methods that embody various aspects of the present invention. This discussion is included, in part, in order to disclose particularly preferred modes presently contemplated for practicing the invention. It is intended, however, that the previous discussion and the claims not be limited by examples provided herein. It is further intended that the invention be understood broadly in light of the teachings provided herein. Where specific examples are described in detail, no inference should be drawn to exclude other examples known in the are or to exclude examples described or mentioned briefly from the broad description of the invention or the language of the claims.

### BRIEF DESCRIPTION OF THE DRAWINGS

FIG. 1 is illustrates an example overview of objects according to specific embodiments of the present invention.

FIG. 2 is an example block diagram illustrating lifecycle building blocks showing roles, phases, deliverables, resource assignments and the associated documents and parameters, and gate reviews according to specific embodiments of the present invention.

FIG. 3 is an example block diagram illustrating an example six-phase lifecycle according to specific embodiments of the present invention.

FIG. 4 is an example block diagram illustrating various relationships between phases and/or resources according to specific embodiments of the present invention.

FIG. 5 is an example graphical interface showing a Program Workspace showing a Lifecycle according to specific embodiments of the present invention.

FIG. 6 is an example graphical interface showing an example Personal Workspace Dashboard according to specific embodiments of the present invention.

FIG. 7 is an example graphical interface showing an example Resource Assignment interface according to specific embodiments of the present invention.

FIG. 8 is an example graphical interface showing an Enterprise Workspace according to specific embodiments of the present invention.

FIG. 9 is an example graphical interface showing a Program Office according to specific embodiments of the present invention.

FIG. 10 is an example graphical interface for creating a new Program according to specific embodiments of the present invention.

FIG. 11 is an example graphical interface for selecting a Lifecycle for a new Program according to specific embodiments of the present invention.

FIG. 12 is an example of two graphical interfaces showing a Skill-Based User Search and Impact Analysis according to specific embodiments of the present invention.

FIG. 13 is a block diagram illustrating Roles And Resources according to specific embodiments of the present invention.

FIG. 14 is a block diagram illustrating a Role Assignment Process according to specific embodiments of the present invention.

FIG. 15 is an example graphical interface showing an analysis of a Role Assignment according to specific embodiments of the present invention.

FIG. 16 is an example graphical interface showing a Program Managers Role Review screen according to specific embodiments of the present invention.

FIG. 17 is an example graphical interface showing an example of Gate Review Questionnaire according to specific embodiments of the present invention.

FIG. 18 is an example graphical interface showing an example of Entering Metric Values according to specific embodiments of the present invention.

FIG. 19 is an example graphical interface showing an example Gate Review Approval Summary Screen according to specific embodiments of the present invention.

FIG. 20 is an example graphical interface showing schedule Reports for a Program/Lifecycle, a Phase, and a Deliverable according to specific embodiments of the present invention.

FIG. 21 is an example graphical interface showing an example Cost Report according to specific embodiments of the present invention.

FIG. 22 is an example graphical interface showing an example Risk Report according to specific embodiments of the present invention.

FIG. 23 is an example graphical interface showing an example Program Metrics Report according to specific embodiments of the present invention.

FIG. 24 is an example graphical interface showing a Skill Shortfall Report according to specific embodiments of the invention.

FIG. 25 is an example graphical interface showing an example Organization Utilization Report according to specific embodiments of the invention.

FIG. 26 is an example graphical interface showing an example Resource Analysis Report according to specific embodiments of the invention.

FIG. 27 is an example graphical interface showing an example Portfolio Dashboard showing program status according to specific embodiments of the present invention.

FIG. 28 is an example graphical interface showing an example Gate Review Information Summary Report according to specific embodiments of the present invention.

FIG. 29 is an example graphical interface showing an example Bubble Chart Report according to specific embodiments of the present invention.

FIG. 30 is an example graphical interface showing an example Custom Report according to specific embodiments of the present invention.

FIG. 31 is an example graphical interface for adding a new Lifecycle according to specific embodiments of the present invention.

FIGS. 32A and B illustrate example graphical interfaces for displaying and adding Lifecycle Applicability Rules according to specific embodiments of the present invention.

FIG. 33 is an example graphical interface illustrating Phase Contents according to specific embodiments of the present invention.

FIG. 34 is an example graphical interface for adding a Gate Review according to specific embodiments of the present invention.

FIG. 35 is a block diagram illustrating example relationships of Phases or Deliverables according to specific embodiments of the present invention.

FIG. 36 is an example graphical interface illustrating Defining Phase Relationships according to specific embodiments of the present invention.

FIG. 37 is an example graphical interface illustrating Phase Deliverable Information according to specific embodiments of the present invention.

FIG. 38 is an example graphical interface illustrating Deliverable Contents according to specific embodiments of the present invention.

FIG. 39 is an example graphical interface illustrating Defining Deliverable Relationships according to specific embodiments of the present invention.

FIG. 40 is an example graphical interface illustrating Summary Of Deliverable Resources according to specific embodiments of the present invention.

FIG. 41 is an example graphical interface illustrating Creating a New Role according to specific embodiments of the present invention.

FIG. 42 is an example graphical interface illustrating Creating a New Resource according to specific embodiments of the present invention.

FIG. 43 is an example graphical interface illustrating Creating a New Risk according to specific embodiments of the present invention.

FIG. 44 is an example graphical interface illustrating Roles-Based Workflow according to specific embodiments of the present invention.

FIG. 45 is an example graphical interface illustrating a Program Office Metrics Library according to specific embodiments of the present invention.

FIG. 46 is an example graphical interface illustrating Defining a Metrics according to specific embodiments of the present invention.

FIG. 47 is an example graphical interface illustrating Creating a Factor according to specific embodiments of the present invention.

FIG. 48 is an example graphical interface illustrating Defining Factor Values according to specific embodiments of the present invention.

FIG. 49 is an example graphical interface illustrating Values Sets for Codes according to specific embodiments of the present invention.

FIG. 50 is a block diagram showing a representative example networked information device and server system in which various aspects of the present invention may be embodied.

### DESCRIPTION OF SPECIFIC EMBODIMENTS

In the following detailed description, the present invention is described with reference to a comprehensive networked-enabled software product named Novare™, which in various aspects embodies aspects of the present invention. At present, one version of the Novare™ application is implemented using Livelink®. Livelink® is a scalable collaborative commerce application/programming environment for developing Web-based intranet, extranet and e-business solutions. It will be understood to those of skill in the art that the present invention (including the Novare™ embodiment) can be implemented using other implementation platforms, such as Java, C++, etc.

The present invention is best understood through of a series of illustrative user interface screens and underlying data models that illustrate aspects of the invention. In the particular discussed embodiments, these user screens are typically accessed and displayed through a browser and are available over a network, as will be understood to ordinary practitioners in the art. However, given the user interfaces and teachings provided herein, it is within the skill of an ordinary practitioner in the art to implement the user interface screens and back-end support functionality in various implementation environments.

Furthermore, the present discussion is intended for those knowledgeable in the art, including the art of enterprise software applications, including enterprise browser-based software applications. Thus, this discussion does not various functionalities commonly understood in such applications, including commonly understood functions of the illustrative user interfaces provided. Thus, general methods of using graphical interfaces, and common functions such as email, discussion threads, electronic document and forms handling, user permissions and authorizations, task list, and other functions known in the art are not discussed at length herein in order to provide a clearer illustration of the novel aspects of the present invention. Aspects of the Livelink programming environment used to support the invention are also not discussed in detail.

According to specific embodiments, the present invention involves a network enabled software system for integrating and coordinating the tasks and information needed by a team of users participating in Product Lifecycle Management (PLM). A comprehensive software system according to specific embodiments of the present invention supports the development, launch, and management of products and services through to retirement. As such, methods and systems of the invention can be applied to New Product Development (NPD); New Product Introduction (NPI); End of Life Management (EOL); and Product Portfolio Management (PPM). In specific embodiments, the invention can be understood through a series of graphical interfaces that allow different types of users to perform necessary tasks and review pertinent information. These graphical interfaces, according to specific embodiments of the present invention, can be provided through web browsing application that allows user access over a private network or a public network, such as the Internet.

1. System Objects and Components

Object Descriptions

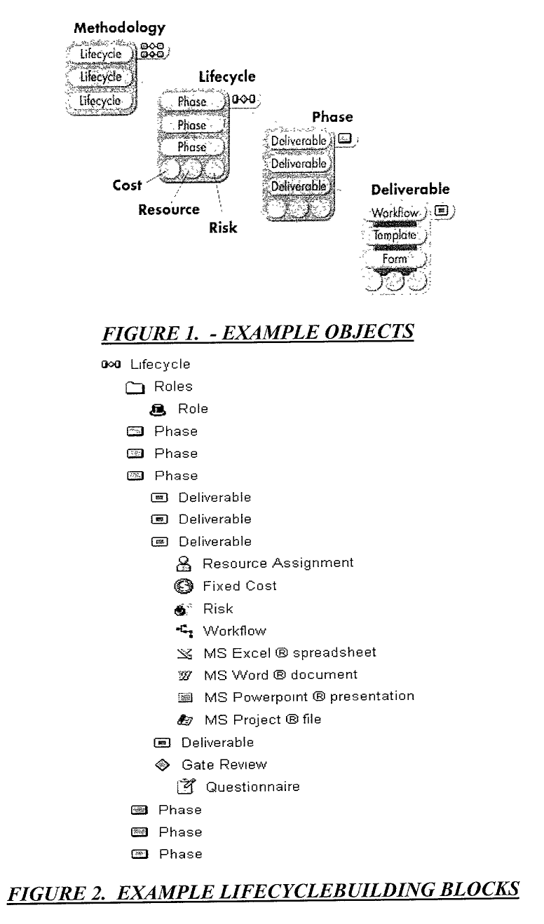

According to specific embodiments, the invention provides and manages a number of data objects (referred to herein as Business Model Objects, Methodology Objects, or Objects) and a number of components, roles, states, codes, or metrics that can be assigned to various Objects. This section discusses various Business Model Objects and aspects thereof, in general terms, and then discusses their use. It will understood from the teachings herein that not all the different types of objection or their subparts herein described are necessary in all embodiments of the present invention. FIG. 1 is illustrates an example overview of objects according to specific embodiments of the present invention. The immediately following discussion provides an overview description of the various objects and how they can be related to each other to model a business development process. Other sections describe example interfaces and methods for interacting with objects during a Program execution. Still other sections describe example interfaces and methods for creating objects and establishing relationships according to specific embodiments of the present invention.

Methodology

According to specific embodiments, the invention allows a user to establish and maintain a Methodology Library of internal best-practice Lifecycles. In order to easily and quickly build and organize different Lifecycles, the invention provides a set of Object building blocks. These objects represent different levels such as “macro” processes and “micro” processes. Different object types can have business rules that govern its behavior and in particular, its relationships with other objects. While Methodologies are optional in embodiments of the invention, they provide a convenient way for a company to many different lifecycles. Thus, Lifecycles intended for similar products, or for specific business units, can further be grouped into Methodologies. For example, a company may have a Methodology for software development and another for hardware development. Each Methodology can contain a Lifecycle for each category of new product that business unit creates. Methodologies help in the designing and organizing of Lifecycles. Types of Methodologies might include: New Platform Products, Product Line Extensions, Cost Reductions, etc.

Lifecycle

A Lifecycle is a process model that can be used as a template to guide a Program through to completion. The invention can capture a company's unique approach to developing and introducing new products in the form of a Lifecycle. A Lifecycle is a complete roadmap that outlines how to get from an idea to a successful new product. It contains everything team members will need to accomplish their assignments along the way, including document templates, examples of work, electronic forms, etc. Different Lifecycles often exist in a Methodology Library corresponding to such characteristics as business unit, Program family, product line, and customer. A Lifecycle available for use in executing a Program is referred to as a Library Lifecycle. A Lifecycle in use in an executing Program is referred to as the Program Lifecycle. FIG. 2 is an example block diagram illustrating lifecycle building blocks showing roles, phases, deliverables, resource assignments and the associated documents and parameters, and gate reviews according to specific embodiments of the present invention.

Program

A “Program” as referred to herein, is a specific instance of using a Lifecycle to complete a specific end product. Generally, every program to develop a product, service or process has unique characteristics and needs. These unique needs may be driven by different requirements: external (e.g., regulatory compliance or customer requirements) or internal (e.g., time to market or budget constraints). A Lifecycle according to specific embodiments of the present invention can be adapted to fit the constraints imposed on any program or process for development.

Phase

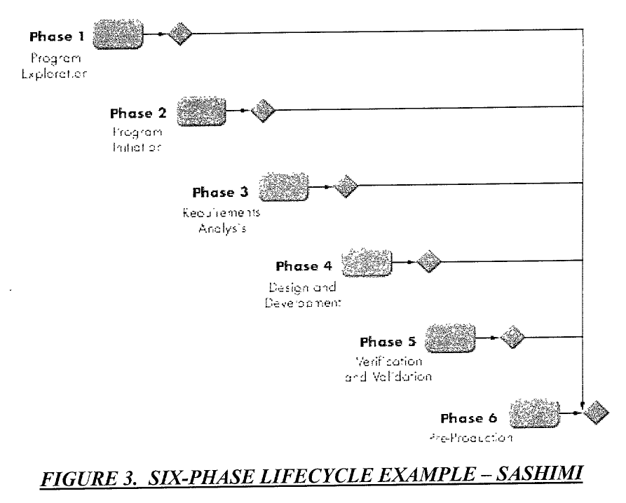

According to specific embodiments, the present invention supports Stage-Gate™ (a trademark of the Product Development Institute) or Phase-gate approaches to PLM. Each Lifecycle can be broken down into large blocks of work that are called Phases. For example, a Lifecycle might start with a Justification Phase, followed by an Exploration Phase, which must be completed prior to undertaking a full-fledged Development Phase. Each Phase can include a Gate Review, an evaluation point where the health and attractiveness of the Program is assessed and where a “Go/No Go” decision is made. FIG. 3 is an example block diagram illustrating an example six-phase lifecycle according to specific embodiments of the present invention.

Role

Each Lifecycle has a set of Roles that must be filled by users with specific skills. Roles might include such things as a Lead Software Engineer, a Product Manager, or a Manufacturing Engineer. The users that fill the Roles are responsible for accomplishing various Resource Assignments requiring their unique skills.

Deliverable

A Deliverable is a clearly defined, formal outcome. Various tools such as workflows, electronic forms, and document templates can be provided to help complete Deliverables. Like Phases, Deliverables can also have relationships with other Deliverables. Each Phase of a Lifecycle can contain a number of Deliverables that represent discrete work products that will be completed during that Phase. For example, an Exploration Phase might involve two Deliverables (1) writing a proof of concept document and (2) building a prototype. Deliverable Objects can contain all the supporting information users will need to complete them (such as documentation, costs, forms, etc.), as well as Resource Assignments that specify the amount of work to be accomplished over a period of time.

Relationships/Schedules

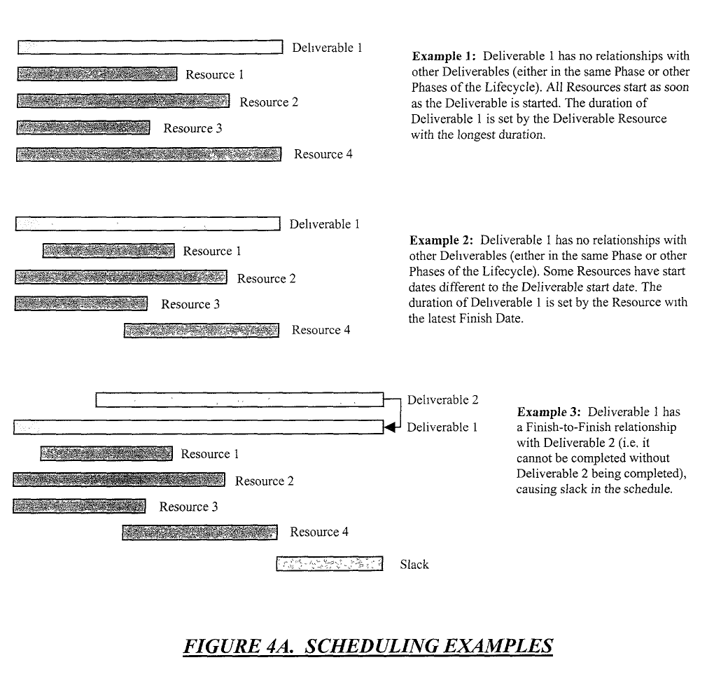

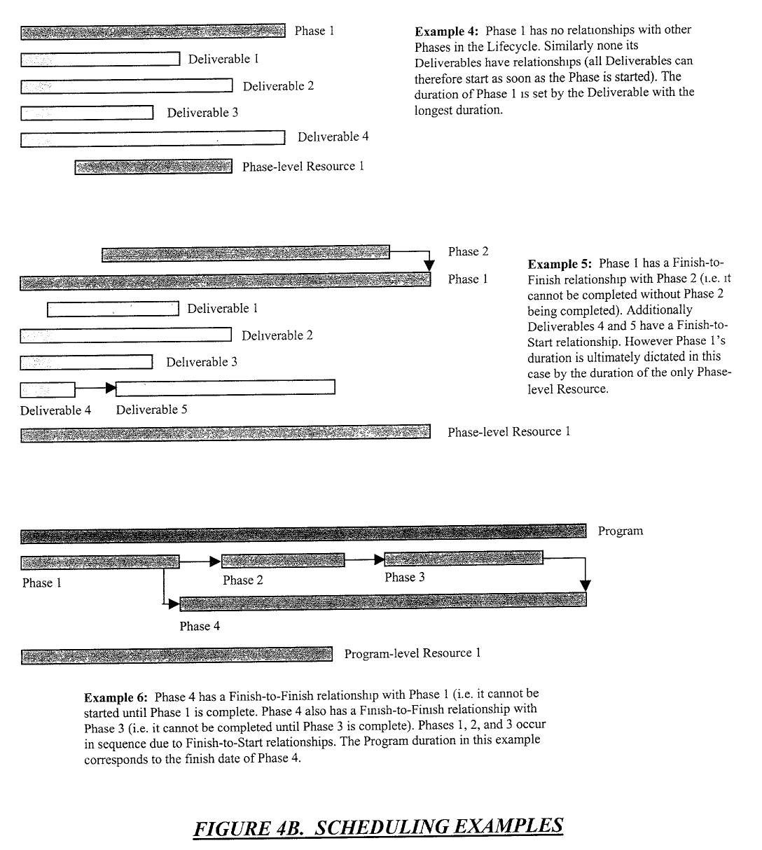

Relationships between Phases and Deliverables can be defined to determine the sequence of events that will take place over the course of the product's development and introduction (i.e. over the course of Program Execution). A system according to specific embodiments of the present invention can support very complex Lifecycles, and easily accommodates overlapping or parallel Phases. FIG. 4 is an example block diagram illustrating various relationships between phases and/or resources according to specific embodiments of the present invention.

The invention manages Schedule information based on the duration of Resource Assignments and any relationships between Phases and between Deliverables within the Lifecycle. Thus, the invention captures Plan, Forecast, and Actual Schedule information. For a Lifecycle in the Methodology Library, summary Schedule reports are provided at the Lifecycle, Phase, and Deliverable levels. Only Plan Schedule information is supported within the Methodology Library (there are no Forecast or Actual values for a library Lifecycle).

Later, when a Program uses that Lifecycle, summary Schedule reports are also provided at the Program and Portfolio levels. Plan, Forecast, and Actual Schedule information is supported on a Program. The Development Engine can be configured to exclude weekends from schedule calculations.

Resources, Costs, and Risks

A Lifecycle, Phase, and/or Deliverable can all have associated Resources, Costs, and Risks. Such items are referred to as Lifecycle-, Phase-, or Deliverable-level Resources, Costs, and Risks respectively. Resources are assignments to perform work on a Program, and are assigned to a Role. Resources have Start Dates, Finish Dates, Duration, and Work plan estimates. Costs are fixed costs (compared with variable costs associated with Resources). Finally Risks represent expected Risks likely to have a negative impact on a Program's chances of success.

Costs

According to specific embodiments, the invention manages both fixed Cost information and variable Cost information. Fixed Costs such as facilities or equipment costs are tracked using the Cost objects, and are associated with Lifecycles, Phases, and Deliverables. Lifecycle fixed Costs will later apply to the Program itself, independent of the Phases that constitute the Program Lifecycle. Phase Costs apply to the Phase, independent of that Phase's Deliverables. Lastly Deliverable Costs apply to the Deliverable itself.

Variable Costs refer to Resource Costs. To provide flexibility, these rates can be applied in a number of different ways: (1) Assigning users with Resource Classifications that define burdened/unburdened rates (2) Assigning a Resource Classification directly to a Role (that is then assigned to a user) (3) Assigning a rate directly to a Role. Variable Costs are based on the rate information and the amount of work to be performed on the Resource Assignment. In the case of both fixed and variable Costs, the invention captures Plan, Forecast, and Actual Cost information.

For a Lifecycle in the Methodology Library, summary Cost reports are provided at the Lifecycle, Phase, and Deliverable levels. Only Plan Cost information is supported within the Methodology Library (there are no Forecast or Actual values for a library Lifecycle). Later, when a Program uses that Lifecycle, summary Cost reports are also provided at the Program and Portfolio levels. Plan, Forecast, and Actual Cost information is supported on a Program.

Risks

The invention manages Risk information through the use of Risk objects that can be associated with Lifecycles, Phases, and Deliverables. Lifecycle Risks will later apply to the Program itself, independent of the Phases that constitute the Program Lifecycle. Phase Risks apply to the Phase, independent of that Phase's Deliverables. Lastly Deliverable Risks apply to the Deliverable itself. Risk values are based on the Risk's Probability and Impact, providing a value for individual Risks. For a Lifecycle in the Methodology Library, summary Risk reports are provided at the Lifecycle, Phase, and Deliverable levels. Later, when a Program uses that Lifecycle, summary Risk reports are also provided at the Program and Portfolio levels.

States

In general, Business Objects (except, for example, Cost objects) use States that define business logic and business relationships. States govern a number of characteristics associated with each object, such as what activities can occur in a particular state or which information is displayed for an object based on its state. The following table presents an example list of Object Types and possible States for each type. The functionality of the states is indicated by the state name shown in the table and can be further understood from the teachings herein.

TABLE 1
EXAMPLE OBJECT STATES

| Object | States |
|---|---|
| Methodology | Draft, Complete, Archive |
| Lifecycle | Draft, Complete, Archive |
| Phase | Pending, Planning, Active, Complete, Inactive, Canceled |
| Deliverable | Pending, Active, Complete, Inactive, Canceled, |
| | Suspended |
| Resource | Pending, Active, Complete, Inactive, Canceled |
| Risk | Library, New, Active, Resolved |
| Role | Unassigned, Requested, Approved, Accepted, Rejected |
| Gate Review | New, Active, Pass, Conditional Pass, Fail |
| Questionnaire | Active, Complete |
| Metric | Draft, Complete, Archive |

2. User Roles

According to specific embodiments, the present invention brings together various participants involved in the PLM process. These participants can range from members of internal organizations—such as Marketing, Engineering, Quality Assurance, Manufacturing, Support, Finance, and Sales—to business partners, suppliers and customers. All contribute to varying degrees in the different stages of a product's Lifecycle.

Different types of user are described in Table 2. Example User Types. According to specific embodiments of the present invention, each type has an associated set of permissions that determine what the user can see and do within the application. It will be understood from the teachings herein that not all the user types shown will be possible in every embodiment of the invention and that not all allowed user types must be defined in particular programs, lifecycles or methodologies. In further embodiments, external participants (customers, suppliers, and design partners) can be involved into the PLM process using a secure extranet. A comprehensive set of permissions lets a system administrator control exactly what participants can see and do.

TABLE 2
EXAMPLE USER TYPES AND ROLES

| User Type/Description | Responsibilities |
|---|---|
| Process Architects are responsible for defining a | Defining Processes—creating processes that will |
| company's best approaches to developing or | be followed on development programs. |
| introducing new products and determining when | Managing Process/Product Metrics—creating |
| these approaches should be used. Process | and maintaining metrics that measure programs |
| Architects have a strong knowledge of a | attractiveness and performance for use in |
| company's development processes and applicable | program and portfolio reviews. |
| industry standards. | Implementing Process Improvement— |
| | incorporating organizational learning from |
| | program post-mortems.. |
| Program Managers are primarily responsible | Planning the Program—tailoring a program plan |
| for budget, schedule, and overall management of | based on its unique requirements and |
| their programs. A Program Manager may be | organizational constraints. |
| responsible for a single large program or multiple | Providing Program Oversight—managing |
| smaller programs. | schedule costs and risks during the execution of |
| | the program. |
| | Communicating Status—providing regular |
| | and meaningful status information and reports to |
| | Executive Managers. |
| Executive Managers are the CEOs, | Strategic Portfolio Management—ensuring the |
| Presidents, VP's, etc., of an organization who are | portfolio is balanced and aligned with business |
| responsible for strategic direction and oversight of | strategy. |
| groups of programs. Executive Managers are able | Program Selection and Prioritization— |
| to access all Program Workspaces and view | determining which group of programs to invest |
| sensitive financial information. They can also | in to maximize returns. |
| modify traffic light status indicator tolerance limits | Strategic Program Management—providing |
| and access all portfolio reports. | executive oversight of the organization's |
| | programs. |
| Individual Contributors (“Team Members”) | Completing Assignments on Programs— |
| are members of a program team. They are | recording progress information and leveraging |
| responsible for completing tasks and contributing | the templates and tools provided to complete |
| to the success of a Program. | work products. |
| | Reviewing Deliverables reviewing and |
| | approving deliverables as complete. |
| | Participating in Gate Reviews—completing |
| | a questionnaire as part of a gate review (program |
| | review). |
| Financial Planners are responsible for | Financial Oversight—tracking of incurred and |
| tracking the financial performance of programs and | remaining costs associated with programs. |
| maintaining financial information, such as net | Providing Financial Data—providing data for |
| present value (NPV) and return on investment | the financial metrics used in program evaluation. |
| (ROI). Financial Planners have full access to | |
| financial information on all programs. | |
| Organization Managers (“Functional Managers”) | Approving Assignments—reviewing and |
| are responsible for providing resources to staff | approving the assignment of resources to |
| programs. They must also monitor resource | programs |
| utilization and plan for future requirements. | Monitoring Resource Use—analyzing resource |
| | utilization and portfolio staffing requirements. |

3. Workspaces

Program Workspace

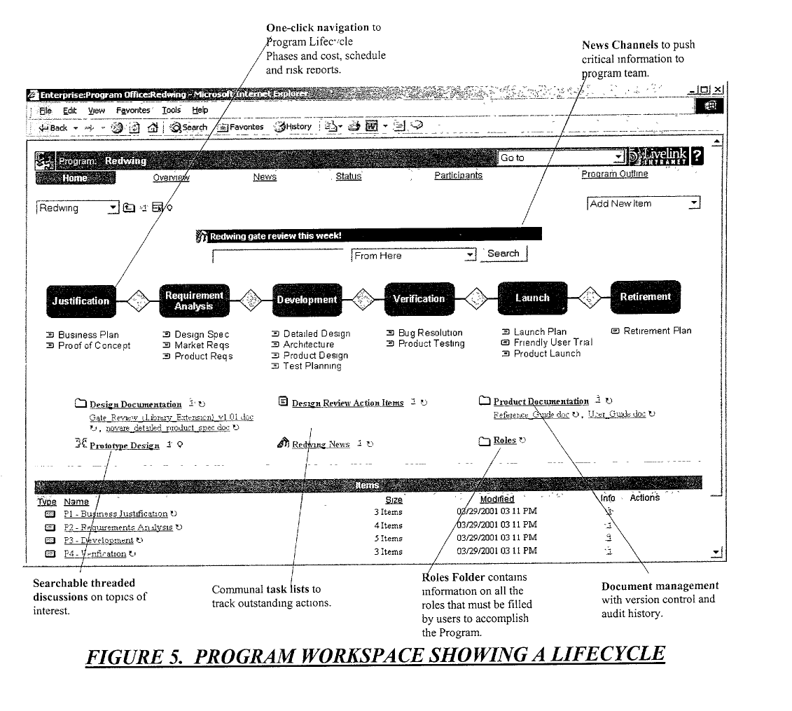

Once captured, a Lifecycle can be instantiated in a Program and automated in a portal called the Program Workspace. When a new Program is added, a unique Program Workspace is created and automatically populated with all the information contained in the selected Lifecycle. The Program Workspace is where the invention brings the Program plan to life, managing the cascade of development activities and routing work packages from one team member to the next. News channels, threaded discussion, search technology, task lists, and document sharing facilitate collaboration and ensure everyone is working with the latest information. Real-time status reports on cost, schedule, risks, and metrics keep users informed of Program progress. From this network-based workspace, the invention automatically routes work assignments and data to team members' in-boxes based on the Program's progress. The Program Workspace is a central location for the Program where all the participants involved can collaborate and share information. FIG. 5 is an example graphical interface showing a Program Workspace showing a Lifecycle according to specific embodiments of the present invention.

Personal Workspace

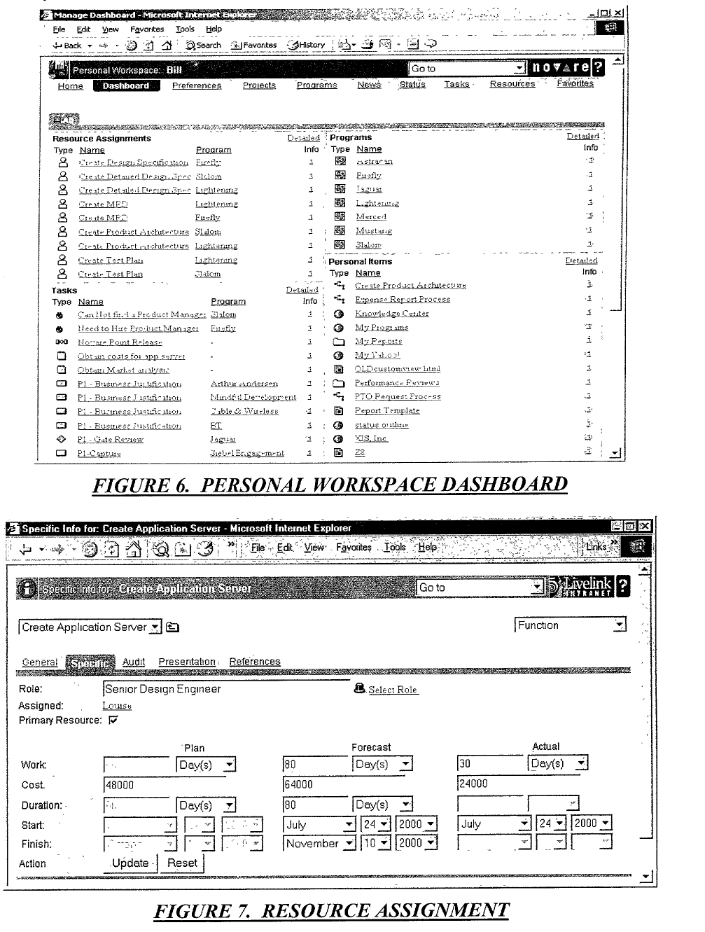

The Personal Workspace is where a user receives their assignments. FIG. 6 is an example graphical interface showing an example Personal Workspace Dashboard according to specific embodiments of the present invention. Work that must be accomplished in the context of a Program appears in a task list in the form of a Resource Assignment. Assignments are sent in a just-in-time fashion based on a user's role on a Program, dependency relationships, Program schedule, and work accomplished to date. Each Resource Assignment is associated with a Deliverable that contains everything needed to complete the assignment. A Resource Assignment contains plan, forecast and actual information for the work to be accomplished in a specific time frame.

A Program Manager or Executive Manager may receive process assignments in their Personal Workspace, such as planning a Phase prior to its activation, responding to a Questionnaire, or participating in a Gate Review. A user acting as a Process Architect, might receive tasks related to defining a Lifecycle or maintaining the Metrics used to measure Program performance and attractiveness.

FIG. 7 is an example graphical interface showing an example Resource Assignment interface according to specific embodiments of the present invention. As show in the figure, this interface provides data fields for Work, Cost, Duration, Start Date, and Finish Date and these fields are displayed in three categories: Plan, Forecast, and Actual. According to specific embodiments of the present invention, a typical user cannot change the Plan data for their assignments, but can change data for Forecast and Actual. Thus, as described elsewhere herein, the overall system can detect slippage in Plans by comparing various user's Forecast and Actual data to the Plan data. In some embodiments, however, Plan and Forecast data can change, however, in response to other Object changes, (such as a delay or speed up in an earlier phase) and this change will be reflected globally to all users. Where there are object dependencies, Work, Cost, Duration, Start Date, and Finish Date data can also change to reflect changes in other objects.

Enterprise Workspace

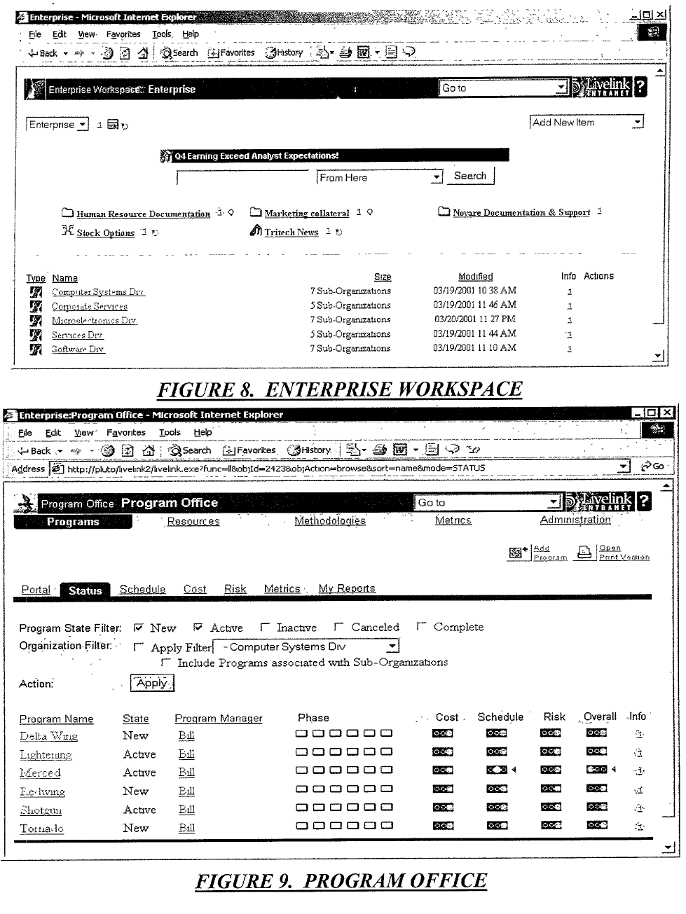

At initial login to a system according to the invention, a user can be presented with an Enterprise Workspace, a communal space for sharing information company-wide (see FIG. 1.3—Enterprise Workspace), such as the latest company news, the most recent versions of public documents, etc. FIG. 8 is an example graphical interface showing an Enterprise Workspace according to specific embodiments of the present invention.

Portfolio/Program Office Interface

Program Office is a central location for company-wide management of Programs. This is where Program Managers can create Programs and access customizable multi-Program and portfolio reports. FIG. 9 is an example graphical interface showing a Program Office according to specific embodiments of the present invention. In this and other examples, Phase information is presented graphically showing which Phases in the Lifecycle are Pending or Planning, Active, and Complete. For example, phases can be indicated on a display or printout as follows: Complete (blue or dark gray), Active (yellow or light gray), Pending or Planning state (white).

4. Executing and Managing Programs

Program Planning

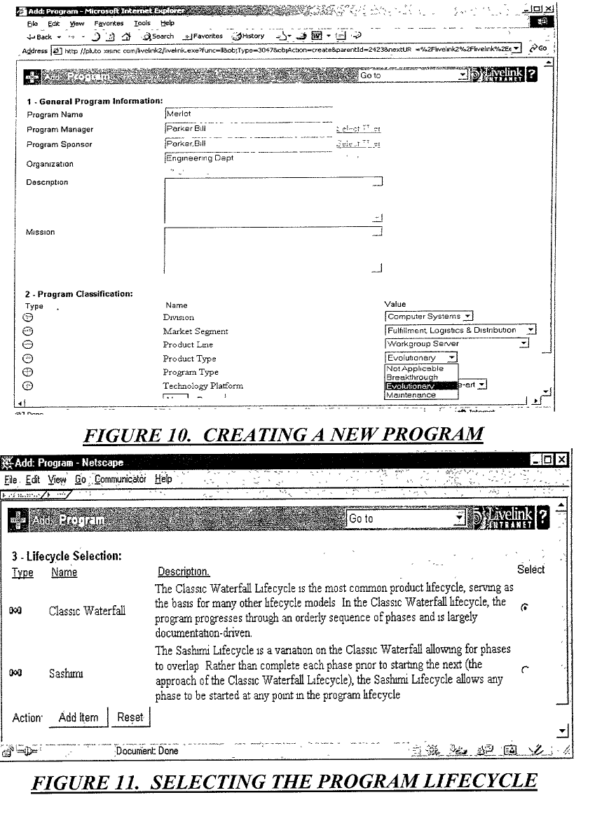

According to specific embodiments of the present invention, creating a Program involves completing a two-step wizard: (1) Creating the Program (2) Selecting a Program Lifecycle. Creating a Program requires providing certain background information and can also including classify the Program using Codes. This information facilitates the classification of the Program and the selection of the most appropriate Lifecycle from the Methodology Library. FIG. 10 is an example graphical interface for creating a new Program according to specific embodiments of the present invention. According to specific embodiments of the present invention, each Lifecycle has an associated set of Codes that determine what type of programs is can be used on. Using Codes, a system according to the invention can determine what Lifecycles are the most appropriate for a Program. When a Process Architect creates a lifecycle he also establishes business rules that determine the Lifecycles availability to different Program, based on their classification Codes. Based on the way a Program is classified, the invention can provide a Program Manager a subset applicable Lifecycles. FIG. 11 is an example graphical interface for selecting a Lifecycle for a new Program according to specific embodiments of the present invention.

Once a Lifecycle is defined and selected, execution of that Lifecycle for a particular Program can be automated in a Program Workspace. According to specific embodiments of the present invention, Program Managers do not have to start from scratch when planning a Program. They benefit from baseline schedule, cost, and resource information that is already part of the selected pre-defined Lifecycle. A Program Manager tailors the baseline plan in the selected Lifecycle to meet the unique needs of his particular Program.

Tailoring and Planning the Program

Although the Lifecycle selection process provides a Lifecycle that matches Program requirements, a Program Manager will likely have to tailor a Lifecycle to fit the unique requirements of a particular Program. At the end of the tailoring process, the Program Lifecycle will act as the overall Program plan against which Program performance will be measured and tracked. The Process Architect defines the degree to which a Lifecycle can be tailored. Tailoring and planning can occur in the following areas: Phases, Deliverables, Resources, and Roles. A Program Manager can tailor Phases in a number of different ways, such as Adding a new Phase, Modifying Phase Relationships, Modifying how Deliverables are managed, Setting options for Phase completion, and Assigning Phase GateKeepers. Depending on the constraints imposed on the Phase by Process Architects, it may also be possible to modify relationships between Phases. When a Gate Review is required, a Program Manager chooses users that will act as GateKeepers. During a Gate Review, GateKeepers are responsible for determining the outcome—Pass, Conditional Pass, or Fail. According to specific embodiments of the present invention, to complete a Deliverable, a review and approval cycle is required. During this review, Deliverable Approvers will either Approve or Reject the Deliverable. A Program Manager defines which Team Members will act as Deliverable Approvers using a provided interface. When a Deliverable is ready for review, the Primary Resource is responsible for initiation the approval process. A Program Manager can define which team member will act as Primary Resource in the Resource itself, or in the parent Deliverable.

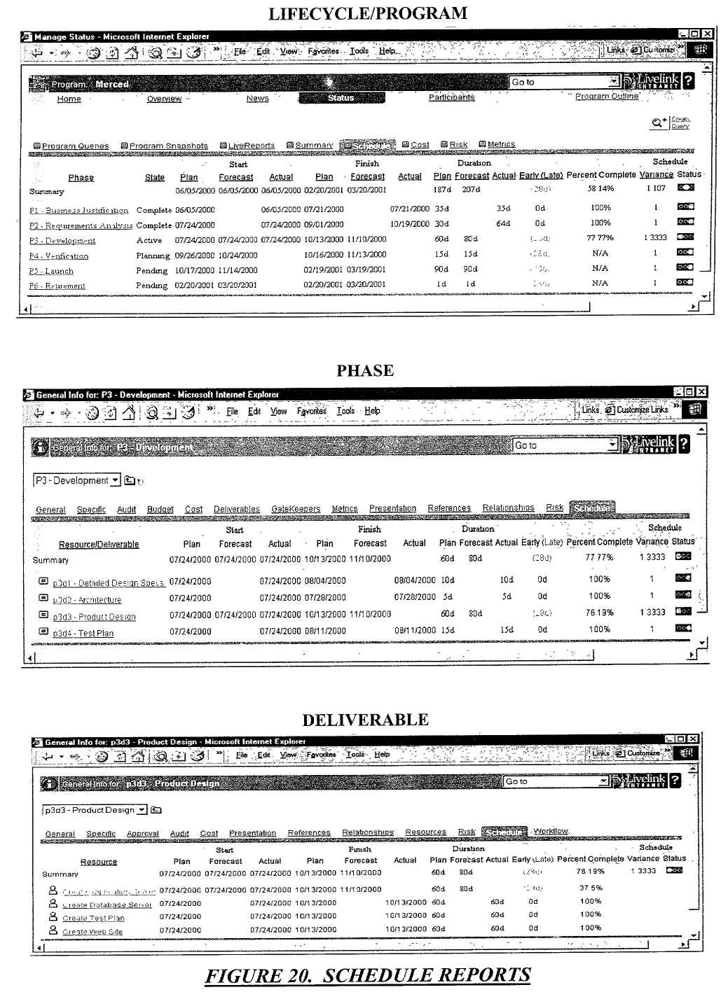

A Program Schedule Report displays overall Program Schedule status and a detailed Schedule roll-up summary for each Phase (See FIG. 20). A user can drill down to obtain more detailed information for each Phase by clicking on the Phase traffic light indicator. A number of common functions can be provided in a Program Workspace, such as Shared Documents, Discussion Groups/Threads, etc. A Participants screen lists the members of the Program Team. Every Program has a team that consists of one or more coordinators, members, or guests. The Workspace Role column indicates which users or groups are coordinators, member or guests in the context of the Program. The Workspace Role defines what users can see and do in that particular Program Workspace.

Assembling the Program Team using Assisted Automated Negotiations

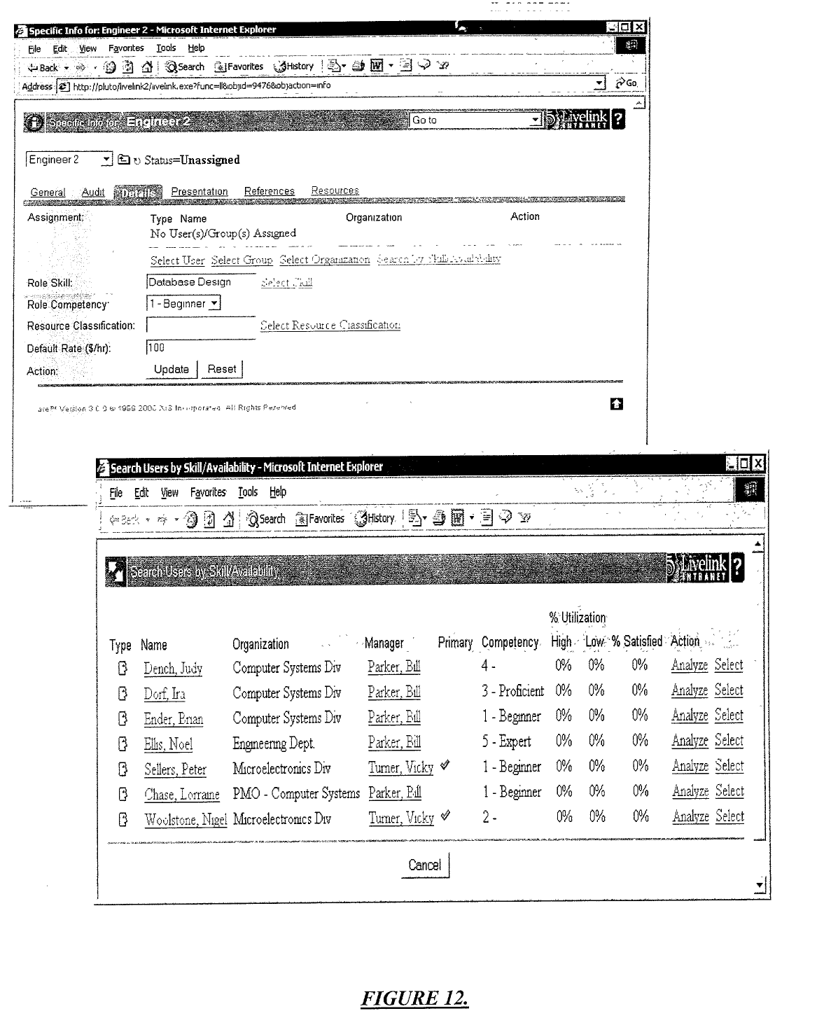

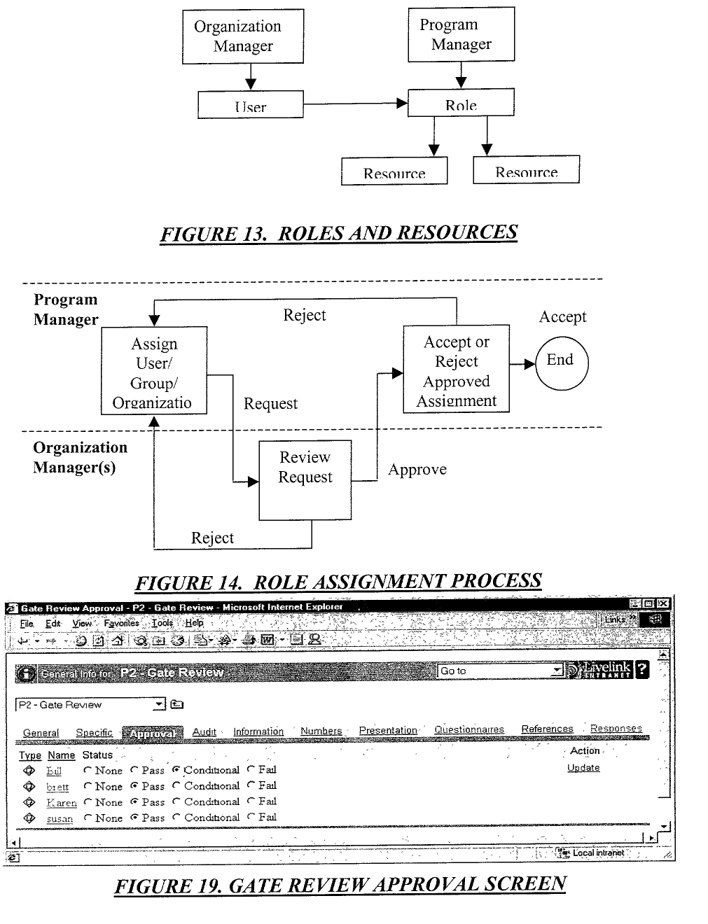

A critical part of Program planning is to assign individuals to Roles. By assigning an individual to a Role, that User is indirectly assigned to any Resource Assignments associated with the Role. When planning is complete, the Program Manager can assign team members the Roles defined in the Program. According to specific embodiments, the present invention facilitates the assignment of users to a Program by automating important steps of the process. The Program Manager can do a rapid, skill-based search of available users, and request either an individual or a group. FIG. 12 is an example of two graphical interfaces showing a Skill-Based User Search and Impact Analysis according to specific embodiments of the present invention. The Organization Manager can then review the request, and approve it, reject it, or propose an alternative, which the Program Manager can, in turn, either accept or reject. According to specific embodiments of the present invention, user interface screens are presented to both the Organization Manager and Program Manger to facilitate these tasks and the tasks are placed in those individuals Task Lists. Once an assignment is made the user is automatically made a member of the program team and gains access to the Program Workspace. According to specific embodiments of the present invention, a Roles Folder can indicate who has been assigned to the Program Roles with a Role state indicating the progress of negotiations for Roles that remain unassigned. FIG. 13 is a block diagram illustrating Roles And Resources according to specific embodiments of the present invention.

The Role Assignment Process

FIG. 14 is a block diagram illustrating a Role Assignment Process according to specific embodiments of the present invention. Program Managers and Organization Managers both participate in the assignment of users to Roles. Initially a Program Manager will request users, Groups, and/or Organizations. Organization Managers are then responsible for reviewing the request and approving the assignment of one of the requested users, or proposing an alternative user. The Role assignment approved by the Organization Manager is then sent to the Program Manager, who can review what user was assigned before accepting the assignment. The user is automatically made a member of the program when the Program Manager accepts the assignment. If the Program Manager does not know exactly whom they want to fill the Role they can request multiple users or Groups. If they want to let the Organization Manager decide which users will fill the Role, they can request an Organization. When users from more than one Organization selected, the request is sent to all appropriate Organization Manager. If the Program Manager is also the Organization Manager of the requested user they can bypass the Role assignment process and accept the users right away. When a Resource associated with a Role that is not yet accepted goes active, it will appear in The Program Manager's Task List until the assignment process completed. Any progress information recorded in the Resource will be maintained when it is transferred to the new users when the Role assignment is finally accepted.

Finding and Requesting Users

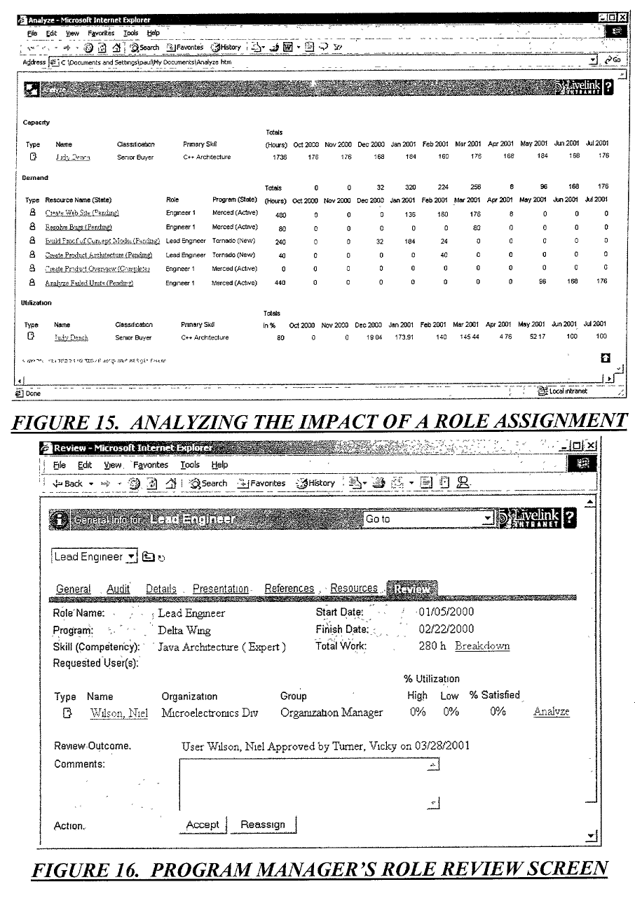

A Role Details screen (an example is shown in FIG. 12) displays the Skill and Competency level this Role requires. Generally, this information was provided by the Process Architect when he created the lifecycle. A Program Manager can search to find available users the have the right Skill to fill the role by clicking on the Search By Skill/Availability link. This search return a list of users with the appropriate skills and a summary of how those users can satisfy the Role and its associated Resource Assignments (an example is shown in FIG. 12). According to specific embodiments of the present invention, Two measures are provided—% Utilization (High and Low) and % Satisfied—calculated for the duration of the Role. % Utilization indicates the users highest and lowest utilization for that period if he where to be assigned to the role. % Satisfied indicates how well the users is able to satisfy the demands of the Role. A more detailed breakdown with which to analyze the impact of assigning a Role to an individual is provided by selecting Analyze. FIG. 15 is an example graphical interface showing an analysis of a Role Assignment according to specific embodiments of the present invention. This feature allows Organization Managers to compare an individual's availability before and after such a Role assignment.

When a Role assignment has been approved or rejected by an Organization Manager, a Role Acceptance Task appears in the Program Managers Task list. The Program Manager can click on the task to access the Role Review screen and review the assignment before accepting or reassigning it. FIG. 16 is an example graphical interface showing a Program Managers Role Review screen according to specific embodiments of the present invention. Reassigning the role makes it unassigned, and the Role assignment process must begin anew. If the Organization Manager did not approve the user(s) requested, and he did not propose an alternative, the Program Manager will receive a Role Rejection Task that will remain in the task list until the rejection is acknowledged by the Program Manager reassigning. The Program Manager can create new Roles as required using a add new item—role interface. If neither a Job Classification nor Default Rate is defined for the Role, the Job Classification of the user assigned to the Role on a Program, will be used to define the Role rate.

Working with Status Indicators

Traffic light Status Indicators are used to summarize Schedule, Cost, and Risk status information for Programs, Phases, and Deliverables. Status Indicators change colors automatically based on the status of the Program, Phase, or Deliverable respectively. The amount of variance required to turn a Status Indicator from one color to another (e.g. green to yellow, or yellow to red) is defined by Tolerance Limits set by Process Architects. A Status Indicator is also used to summarize the overall health of the Program, its Phases, and their Deliverables. Unlike the Schedule, Cost, and Risk Status Indicators, a Program Manager is responsible for manually changing its color.

Applying Overrides to Status Indicators

A Program Manager can apply an override to a Program, Phase, or Deliverable Status Indicator if the Manger feels it does not accurately reflect the real status. Once an Override is applied, an Override Indicator is displayed in reports to the right of the Status Indicator.

Automating Program Lifecycle Execution

When a Program is made Active, the software system will automate the execution of the Program's Lifecycle through to completion. As the team completes the different Resource Assignments, Deliverables, and ultimately Phases, the system updates status information in real time, providing information on performance to Schedule, Cost, Risk, and Metrics. The Development Engine supports a living schedule, where actual performance impacts downstream activities. Schedule changes ripple through the plan and expand or contract it accordingly.

Planning Phases

Planning the First Phase(s)

When the Program is activated, one or more Phases will enter the Planning state depending on the Phase relationships defined in the Lifecycle. For example, in a Classic Waterfall Lifecycle, only the first Phase will enter the Planning state since the second Phase requires the first Phase to be completed before it can begin. However, in the absence of such predecessor relationships, more than one Phase may be able to start when the Program is made Active. The amount of planning required for the first Phase depends on the amount of tailoring performed before the Program was activated. Such planning may include the following activities: Assigning Roles to Program Team Members for all Resources at the Phase level (i.e. independent of a Phase's Deliverables) and within each of the Phase's Deliverables; Assigning Program Team Members as Deliverable Approvers for each Deliverable in the Phase; Reviewing Plan values for Schedule, Work, and Cost (Once the Phase is activated, plan values for Schedule, Work, and Cost cannot be modified—any subsequent changes in these areas are made to the Forecast values).

When a Phase is activated, one or more of its deliverables will be activated depending on the deliverable relationships defined. When a Deliverable is activated all it's resources are also activated. When a Resource is activated no more change can be made to its Plan values. Only the Actual Forecast values can be modified. The Plan values become the baseline against which performance is measured. Any Deliverable with a finish-to-finish relationship will become Active when its parent Phase is activated. Upon activation, resources are automatically sent to the associated user's Personal Workspace and become visible in their Task List. When Workflow is required for Deliverables, the Workflows process is automatically initiated when the Deliverable is activated.

Fixed Costs

When costs are incurred on a Program they can be captured and tracked using the Cost object. A user can associate Costs with Lifecycles, Phases, or Deliverables. Examples of Costs include equipment costs, facilities costs, or consulting fees. Expected program costs are added during the planning stages and tracked during the course of the program. Users can add unexpected costs at any point during Program execution to accurately reflect expenditures. Generally, Any user can create Costs at the Program Phase or Deliverable level

Risks

Every Program faces risks that must be tracked and managed. According to specific embodiments of the present invention, Risks can be associated with Programs, Phases, and Deliverables. Known Risks can be added during the planning stages, and tracked over the course of the program. Unexpected Risks can be added as they arise during the Program. Generally any User can create new Risks at the Program Phase or deliverables level. When a Risk is Active, it appears in the Task list of the User assigned to the Responsible Role. That user is responsible for analyzing and managing the Risk, and updating its status. The Risk will appear their Task list until such time it is resolved.

Gate Reviews

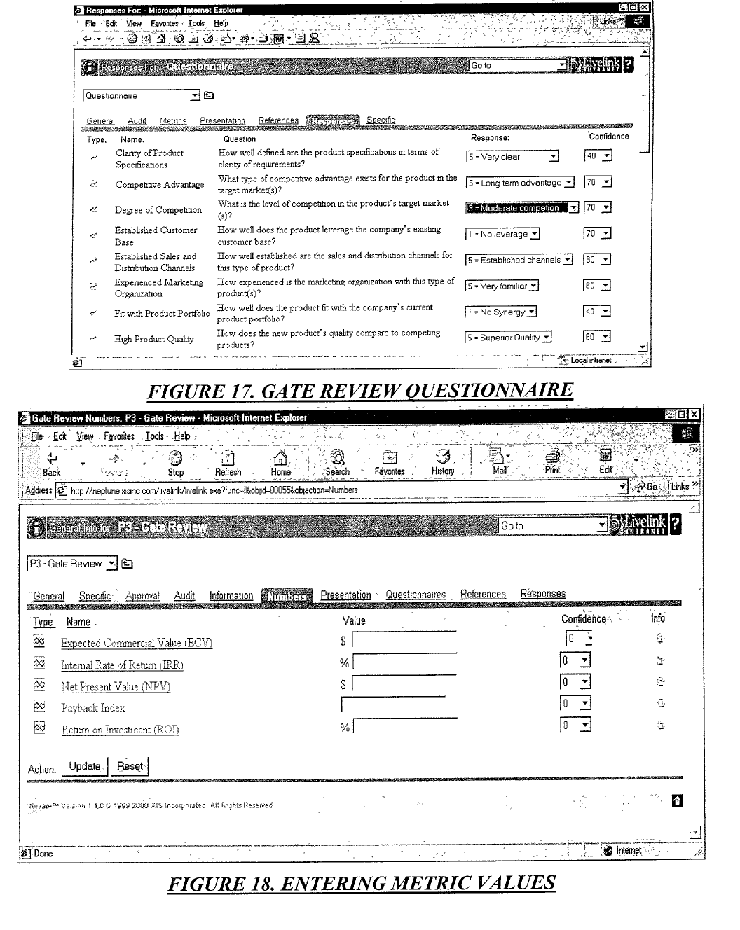

Preparing for a Gate Review involves selecting which Program Team Members will be required to complete Questionnaires. Questionnaires are used to poll recipients about Program, product, and market characteristics. The user responses are use to evaluate the programs health and its attractiveness relative to other programs underway in the company. When the Gate Review is activated, each Questionnaire Recipient receives a Task in their Personal Workspace Tasks List requiring them to complete the Questionnaire. A Gate Review Responses screen gives a preview of the Questionnaire. FIG. 17 is an example graphical interface showing an example of Gate Review Questionnaire according to specific embodiments of the present invention. This is also where the responses from different users are tabulated for discussion during the Gate Review. The average of the respondent's score is presented to a Gate Keeper. If the Gate Keepers agree with the score they can keep it. If not, they can override the average by entering the new question scores in the Gate Keepers own questionnaire and using the override function. While the Questionnaire responses are used to calculate some of the programs attractiveness metrics, a Manager can manually enter other Metric values prior to, or during the Gate Review. FIG. 18 is an example graphical interface showing an example of Entering Metric Values according to specific embodiments of the present invention.

With the Questionnaires completed and the Metrics prepared, the GateKeepers are ready to determine one of three possible outcomes of the Gate Review: Pass, Conditional Pass, and Fail. GateKeepers receive a task to this effect in their Personal Workspace Tasks List. GateKeeprs can enter their disposition as well as view the other GateKeepers dispositions on the Gate Review Approval screen. Once a consensus is reached the final gate decision can be made. FIG. 19 is an example graphical interface showing an example Gate Review Approval Summary Screen according to specific embodiments of the present invention.

In the event of a Pass, the Phase's exit criteria are considered met, and the Program can proceed to the next Phase (or Phases in the case of certain relationships). Any incomplete Deliverables become Suspended.

In the event of a Conditional Pass, most of the Phase's exit criteria are considered met, and the Program can proceed to the next Phase(s) under the condition that incomplete, required Deliverables must be trasfered to future Phases. Upon changing the Gate Review state to Conditional Pass a Deliverable Transfer screen appears and allows a user for each Required Deliverable select the Target Phase, for Optional Deliverables to select a Target phase or choose a “No Target Phase” option. Any required, incomplete Deliverables become Suspended and copies of them are placed in the Phase(s) the GateKeeper selects. These new Deliverables are Pending and will later be activated to allow work on them to continue. All Resources in the Deliverable that were still active at the time of the Gate Review are copied over with the deliverable. However, all actual information is lost, and plan values are reset to a duration of one day and one day of work. The Deliverable must therefore be replanned during the upcoming Phase planning.

In the event of a Fail outcome, the Program can either be cancelled altogether, inactivated for a period of time, or another Gate Review attempted after accomplishing more work.

Automating Program Execution

With the Program team in place, the Program Manager can activate the Program and automate its execution. The invention will send work packages and assignments to the members of the Program team in a just-in-time fashion. Work will progress based on the schedule and assignments accomplished to date, while respecting the business rules defined in the Lifecycle. The result is a living schedule that instantly adapts to the progress on the Program and reflects slips and contractions in the schedule in real-time. During Program execution, this living schedule is compared to the baseline Plan to evaluate Program performance.

Permissions

A set of permissions controls exactly what team members can see and do, based on the role they play in the Program. These permissions make it possible to involve partners, customers and suppliers in the development process, while restricting access to information as appropriate. According to specific embodiments of the present invention, permissions do not have to be managed by a system administrator. Users at different levels can grant other users permissions equivalent to theirs. These ‘granted’ permissions can be revoked at any time. A variety of user interfaces can be provided to grant permissions as will be understood in the art.

Schedule Reports

The invention allows users to access reports on Program performance relative to plan. Schedule slips along the critical path are brought to the surface quickly through indicators (such as traffic light Status Indicators). A user can drill down into the schedule to get to the source of the problem by clicking on the Status Indicator FIG. 20 is an example graphical interface showing schedule Reports for a Program/Lifecycle, a Phase, and a Deliverable according to specific embodiments of the present invention. Note that each screen shows a number of tab options appropriate for that type of object. A Program Schedule Report displays overall Program Schedule status and a detailed Schedule roll-up summary for each Phase. A user can drill down to more detailed schedule information for each Phase by clicking on the Phase traffic light indicator. To navigate within the Schedule reports, click on the traffic light to drill down to the lower level. Click on the browser's Back button to return to the top level. The following information is shown in an example report:

Phase Name—the name of each Phase in the Program Lifecycle

State—state of the Phase (Pending, Planning, Active, Complete, Inactive, or Canceled)

Start Date—Plan, Forecast, and Actual Phase Start Date

Finish Date—Plan, Forecast, and Actual Phase Start Date

Duration—Plan, Forecast, and Actual Phase Duration

Early/Late—How early or late the phase is compared to plan

Percent Complete—overall Phase percent complete

Variance—Phase Schedule variance calculates as the ratio of forecast duration to plan duration. This is an indication of what phases have caused or are causing delays.

Status—overall Phase Schedule status indicator, driven by variance and triggered when specific tolerance limits are met.

Program Cost Reports

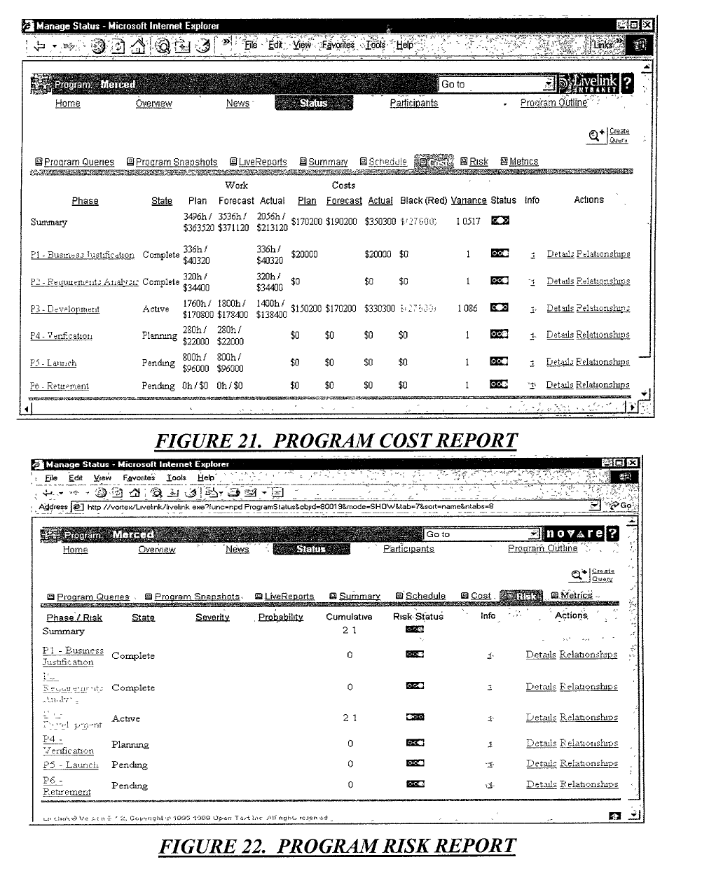

The invention can also roll up and report both variable costs (costs associated with resources) and fixed costs (Program expenses, equipment purchases etc. . . . ) and allows users to drill down on any of the cost reports to access more detailed information. FIG. 21 is an example graphical interface showing an example Cost Report according to specific embodiments of the present invention. A Program Cost Report can display overall Program Cost status and a detailed Cost roll-up summary for each Phase. The Cost report provides the same drill down capabilities as the Schedule report. The following information is shown in an example report:

Phase Name—the name of each Phase in the Program Lifecycle

State—state of the Phase (Pending, Planning, Active, Complete, Inactive, or Canceled)

Work—Plan, Forecast, and Actual cost of the Work involved in the Phase. Work Costs are derived from the hourly Rate of Team Members working on Resource Assignments.

Costs—Plan, Forecast, and Actual total fixed costs associated with the Phase or it's deliverables.

Black/Red—amount by which the Phase is over or under budget.

Variance—Phase Cost variance calculated as a ration of forecast Cost to plan Cost. This provides an indication of which Phases have caused cost overruns.

Status—overall Phase Schedule status indicator that is driven by the cost variance and triggered when specific tolerances are met.

Program Risk Reports

In a similar fashion, the invention can track and report Risks based on their severity and probability of occurrence. The Program Risk Report displays overall Program Risk status and a detailed Risk roll-up summary for each Phase. The Risk report also provides drill down capabilities. FIG. 22 is an example graphical interface showing an example Risk Report according to specific embodiments of the present invention. The risk management process involves assigning a Risk to a team member so it can be monitored or mitigated. The following information is shown in an example report:

Phase Name—the name of each Phase in the Program Lifecycle

State—state of the Phase (Pending, Planning, Active, Complete, Inactive, or Canceled)

Severity—Risk Severity amount, rated on a scale of 1 to 10. (Displayed for Program-level Risks only)

Probability—Risk Probability amount, rated on a scale of 10%-100% (Displayed for Program-level Risks only)

Cumulative—Phase Risk Cumulative total, calculated as the product of the severity and the probability, and summed for all risks in that Phase and it's deliverables.

Status—overall Phase Risk status indicator, which is driven by the cumulative score and triggered when specific tolerances are met.

Program Metrics Report

The Program Metrics Report displays overall Program Metric values based on the last completed Gate Review. FIG. 23 is an example graphical interface showing an example Program Metrics Report according to specific embodiments of the present invention.

5. Organizational Resource Management

Resource Reports

According to further aspects of specific embodiments, the invention offers a set of resource reports that help Executives and Organization Managers understand how well the Programs underway are being met by the current capacity. Capacity, Demand, Utilization, Availability, and Shortfall Reports can be obtained at the company level or for any Organization within the company. An Executive can quickly see the impact of adding a new Program to the portfolio. Skills that are in the greatest demand, and the ones that are imposing constraints on the portfolio can be easily identified.

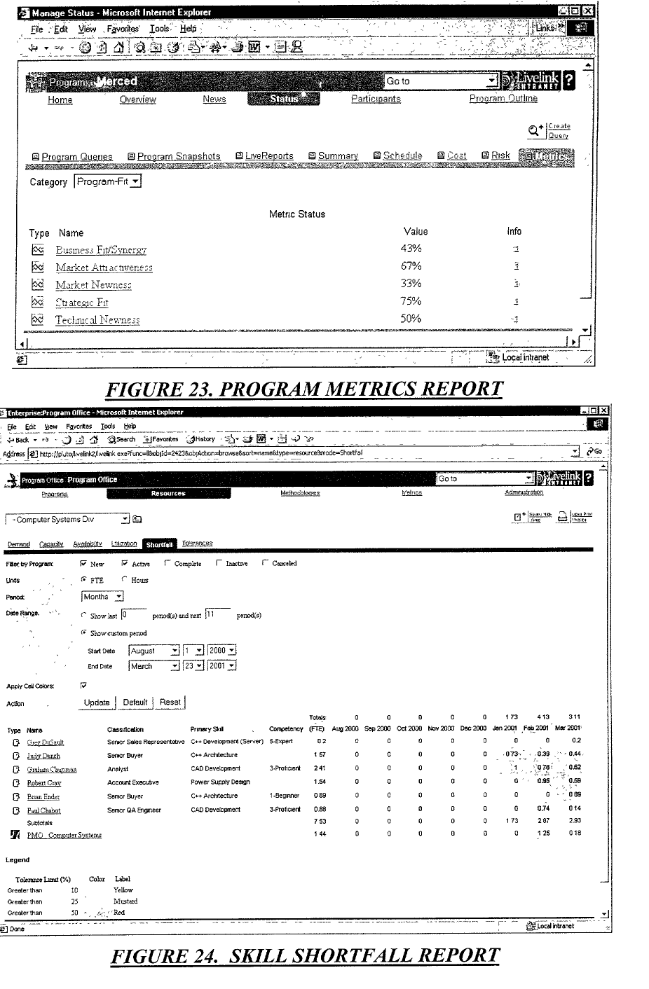

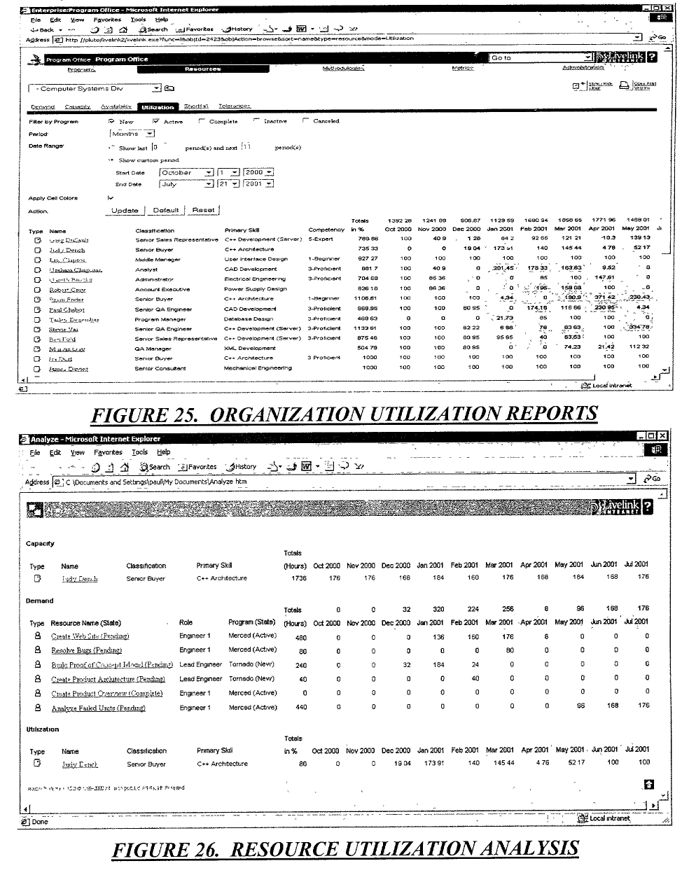

Unlike other tools for providing Organizational Resource Management, a system according to specific embodiments of the present invention, because of the unifying data structure of all programs, allows Organizational Resource information to be gathered during the normal course of Program Execution activities and can automatically aggregate Organizational Resource data. Thus, according to specific embodiments of the present invention, the Organizational Resource data available to Organizational Resource Managers is both more meaningful because it is derived from real-world and real-time data and is easier to acquire because it is automatically gathered from Program Execution data. FIG. 24 is an example graphical interface showing a Skill Shortfall Report according to specific embodiments of the invention. Thus, Functional Managers can assess how well their Organization's resources are utilized. At a glance, they can see which ones are over-allocated and which ones are under-utilized. A simple click provides a breakdown of the demand placed on each user. FIG. 25 is an example graphical interface showing an example Organization Utilization Report according to specific embodiments of the invention. FIG. 26 is an example graphical interface showing an example Resource Analysis Report according to specific embodiments of the invention.

6. Portfolio Management and Analysis

Multi-Program Status Reports: The Portfolio Dashboard

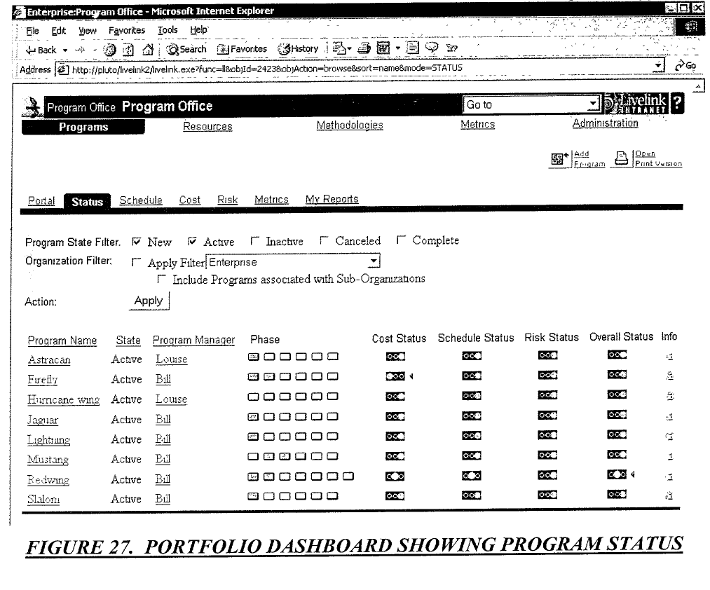

According to further embodiments of the present invention, while the invention is automating the execution of Programs, it gathers progress information and reports it in the form of real-time cost, schedule, resource, risk, and metric reports. The invention can roll-up this information into multi-Program reports that make use of indicators (e.g. traffic lights) to help managers identify trouble spots. Various types of multi-Program reports, data, and/or analysis are referred to herein as Portfolio activity, to indicate that these data are of interest to managers reviewing a Portfolio of development Programs. In this aspect, the invention can provide skill-based resource utilization reports and customizable bubble charts of the product pipeline that facilitate Program prioritization and investment decisions within the Portfolio. A Portfolio Dashboard summarizes the cost, schedule and risk status of multiple Programs. This allows managers to quickly assess the health of Programs and at a glance tell which Programs are off track and drill down to get more detailed information. FIG. 27 is an example graphical interface showing an example Portfolio Dashboard showing program status according to specific embodiments of the present invention.

Program Attractiveness Measures

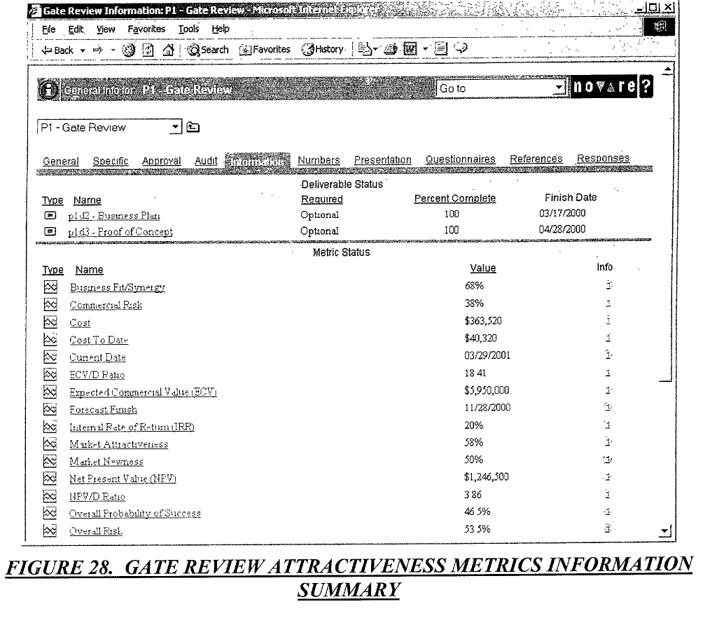

While multi-Program reports on cost, schedule, and risk can indicate whether or not Programs are on track, they do not necessarily help in determining which Programs are worth undertaking. To help determine this, the invention helps compare the relative chance of success of Programs, whether or not they are aligned with strategy, and what return on investment can be expected if they succeed. This kind of assessment requires an understanding of the relative attractiveness of the Programs in a portfolio. Although Program performance is analyzed on an ongoing basis, Program attractiveness is usually assessed at strategic Gate Reviews that occur periodically during the product Lifecycle. Gate reviews typically occur at the end of Phases. At this point, according to specific embodiments of the invention, a dynamically generated questionnaire can be used to poll key stakeholders about the attractiveness of the program from a market, financial, technology and strategic standpoint. The Questionnaire results are used to calculate Attractiveness Metrics. FIG. 28 is an example graphical interface showing an example Gate Review Information Summary Report according to specific embodiments of the present invention.

Portfolio Reports

With the information gathered during automating the execution of Programs, the invention according to specific embodiments can further provide a number of different multi-Program reports for Portfolio analysis.

Bubble Charts

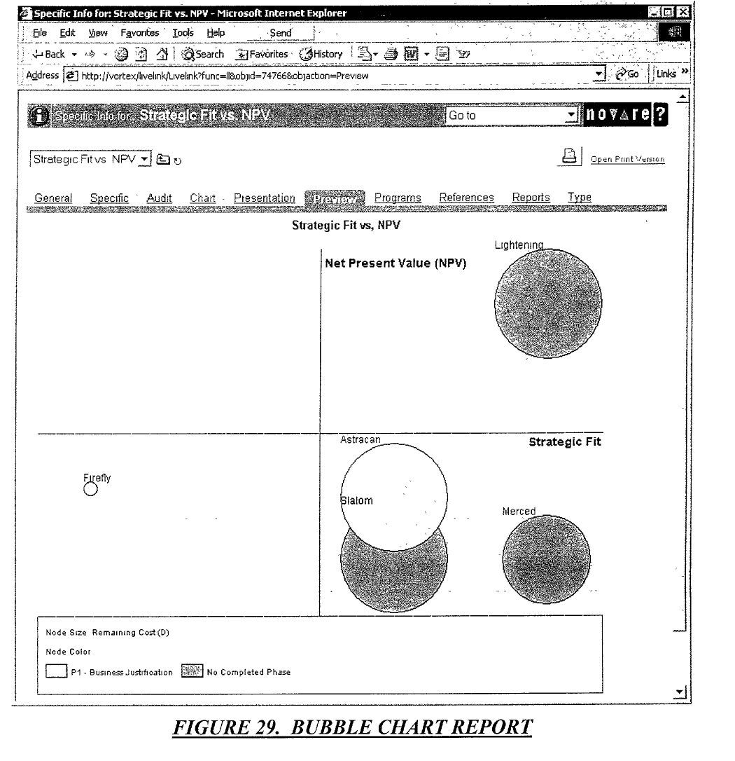

Using Metric data, a user can generate customized Bubble Charts to help Executives assess whether their portfolio is balanced and aligned with strategy (see FIG. 5.3—Bubble Chart Report). Metrics can be derived from Questionnaire scores or can capture financial information such as net present value (NPV) and the internal rate of return (IRR). Others can provide real-time Program information, such as remaining development time and cost to date. As with other dashboard reports, a user can define the subset of Programs the user wants to analyze and the specific Metrics they want to visualize. FIG. 29 is an example graphical interface showing an example Bubble Chart Report according to specific embodiments of the present invention.

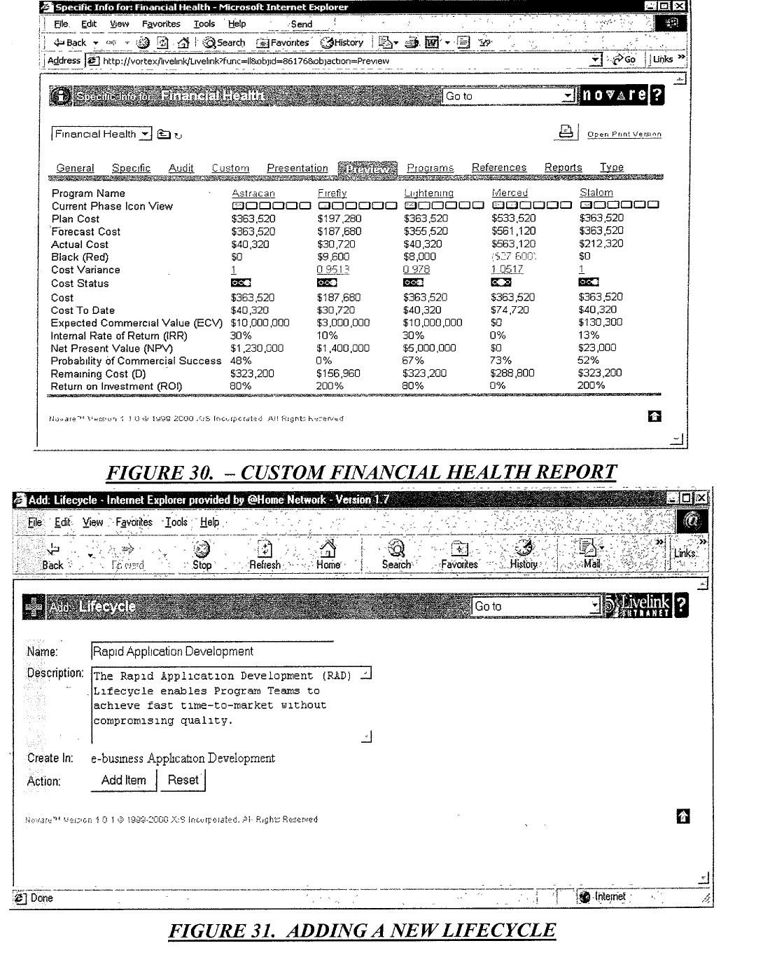

The invention also allows users to create customized reports of the product portfolio by specifying the criteria the user wishes to analyze and the subset of Programs of interest. A user can view any combination of health, performance or attractiveness measures you need to support the analysis and decision making process. FIG. 30 is an example graphical interface showing an example Custom Report according to specific embodiments of the present invention.

7. Creating Business Objects

According to specific embodiments of the present invention, the present invention provides a system that allows authorized users to create a variety of Business Objects, various relationships between Objects, and specify various subpart and characteristics of Objects. In particular embodiments, the invention provides a series of graphical user interfaces for creating different Objects. In further embodiments, the invention can provide one or more wizards for creating or manipulating certain types of Objects. In specific embodiments, these interfaces are designed with a similar look and feel, so that a user familiar with using mechanisms of the invention for adding Lifecycles, can also easily add Phases, Roles, Risks, Costs, Methodologies, etc. Thus, the following discussion does not describe every possible interface provided by a specific embodiment of the invention for creating or manipulating objects, but using the examples provided it would be within the skills of an ordinary programmer to design similar interfaces for all Objects.

Methodologies

Methodologies have three States—Draft, Complete, and Archive that are used to govern the availability of a Methodology's Lifecycles to Programs. To create a new Methodology, a user selects menu commands to add a Methodology and Provides the name and Description (optional) of the Methodology.

Adding Lifecycles

As discussed above, a Lifecycle is composed of multiple Phases and provides a complete process model for a Program. One way to add multiple Lifecycles is to create a baseline Lifecycle and then create Lifecycle copies that are variations of the baseline Lifecycle for different types of Program or product. Variations may be based on budget, scope, size, technology, etc. When a Lifecycle is created, a Roles Folder is automatically created as well. By default, the Roles Folder will include two special Roles—Program Manager and Program Sponsor—that are applicable to all Programs. As a user builds the Lifecycle, he can create additional Roles at any time. He can also add Risks, Costs, and Resources to a lifecycle. These items are referred to as being Lifecycle-level. A user can also add documents such as team handbooks, procedures, and instructions to the Lifecycle.

To create a Lifecycle, a user can, from a Add New Item menu, select Lifecycle and then enter a name a description in the appropriate fields. FIG. 31 is an example graphical interface for adding a new Lifecycle according to specific embodiments of the present invention.

Lifecycle Applicability Rules

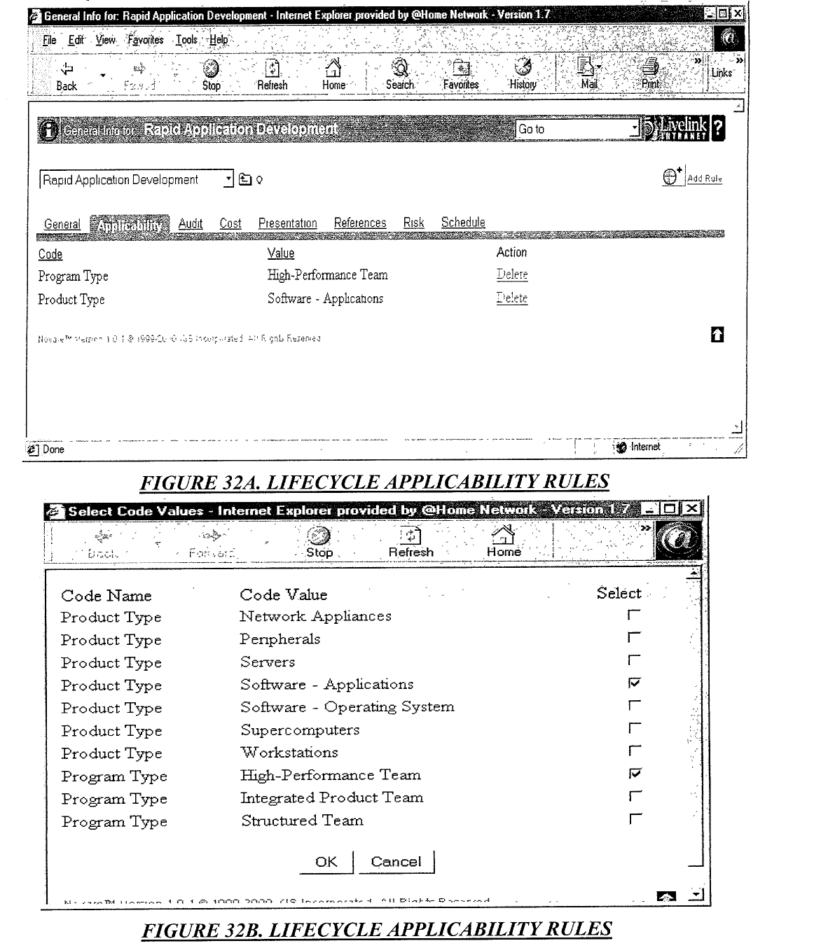

Lifecycle Applicability Rules let a user define business rules that restrict the use of a Lifecycle based on such factors as product type, program type, and market segment. For example, a Spiral Development Lifecycle may only be used in the Software Business Unit provided that the product is not intended for the aerospace and defense market. A user can associate any number of Rules with a Lifecycle. These Rules are based on Codes that have been defined as applicable to Classifying Lifecycles. A user can add new Rules to a Lifecycle provided the Lifecycle is Draft. FIGS. 32A and B illustrate example graphical interfaces for displaying and adding Lifecycle Applicability Rules according to specific embodiments of the present invention. As shown in FIG. 32B, applicability rules can be added by specifying a Code Name and Code Value that define Lifecycle applicability.

Lifecycle Schedule, Cost, and Risk Summaries

As Phases, Deliverables, and Resources are added to the Lifecycle, the Development Engine will automatically generate summary Schedule, Cost, and Risk information. At any time, the information is available from the Lifecycle Schedule, Lifecycle Cost, and Lifecycle Risk screens respectively.

Schedule

The Development Engine will calculate a Plan Finish Date based on Resource duration, Deliverable relationships, and Phase relationships (this date will always reflect the fastest time-to-market). For each Phase in the Lifecycle, an architect can select Relationships and Breakdown to access more detailed Phase relationship and schedule information respectively.

Cost

The Engine calculates all fixed and variable Costs associated with the Lifecycle. Fixed Costs correspond to Cost items associated with the overall Lifecycle, specific Phases, or specific Deliverables. Variable Costs refer to Resource Costs to perform Program work. This Cost information provides a budget estimate for the Lifecycle.

Risk

The Engine calculates all expected Risks associated with the Lifecycle, its Phases, and all Deliverables within the different Phases. The Risk information provides an effective method for gauging Lifecycle Risk based on past experience with that type of Program or product.

It is sometimes useful to export a Lifecycle to either another application, or another installation of the invention. Thus, the invention supports two types of export for Lifecycles: (1) Microsoft® Project Database Record—enables you to analyze Lifecycle models using any project management tool that supports an ODBC database connection with a Microsoft Project® database (2) Text File—allows Process Architects to copy/move Lifecycles between installations.

Building Lifecycles using Phases/Deliverables

Lifecycles are composed of Phases. A Phase represents a discrete step in Lifecycle. Phases may be separated by Gate Reviews. FIG. 33 is an example graphical interface illustrating Phase Contents according to specific embodiments of the present invention. Phases contain Deliverables (designated with a rectangular icon in the Type column), Risks (designated with a bomb icon in the Type column), Resources, and Costs (designated with a “$” icon in the Type column) Any Risks, Resources, and Costs at this level (i.e. independent of the Deliverables in the Lifecycle), represent expected Phase-level Risks, Resources, and Costs respectively.

Options for Phase Completion

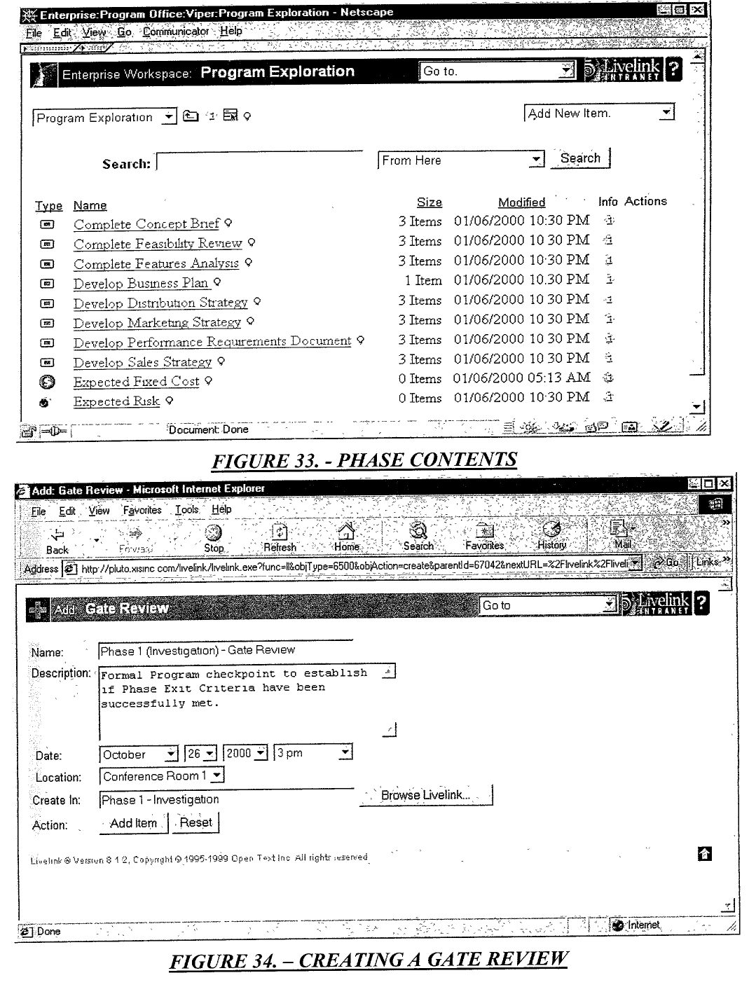

There are two ways a Phase can be completed. If a Gate Review is Required, the Program Manager can only complete a Phase once a Gate Review has been conducted and the outcome of the Gate Review is either Pass or Conditional Pass. If a Gate Review is not Required, the Program Manager may manually complete the Phase, or decide to use a Gate Review. A Process Architect can create a Gate Review in the Phase so the Program Manager does not have to do it later. FIG. 34 is an example graphical interface for adding a Gate Review according to specific embodiments of the present invention.

Establishing Phase Relationships

Defining Relationships Between Phases

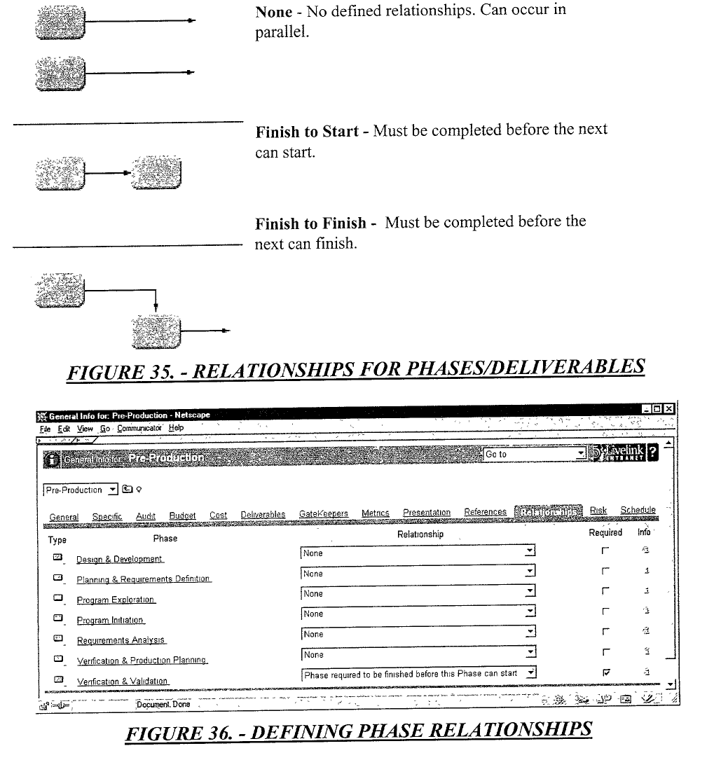

The Relationships screen identifies all relationships between Phase in the Lifecycle. Here, a user can define two types of relationship—Finish to Start, and Finish to Finish. FIG. 35 is a block diagram illustrating example relationships of Phases or Deliverables according to specific embodiments of the present invention. Circular relationships are not permitted as they create dependencies that are impossible to satisfy. A Process Architect can also specify whether these relationships are required or whether they can be tailored by the Program Manager. FIG. 36 is an example graphical interface illustrating Defining Phase Relationships according to specific embodiments of the present invention. Tailoring allows Program Managers to ensure that the Program plan meets the unique requirements of the Program. When the Required checkbox is selected, the Program Manager is unable to edit the relationship. When the Required checkbox is not selected, the Program Manager may edit or remove the relationship.

Configuring Phase Deliverables

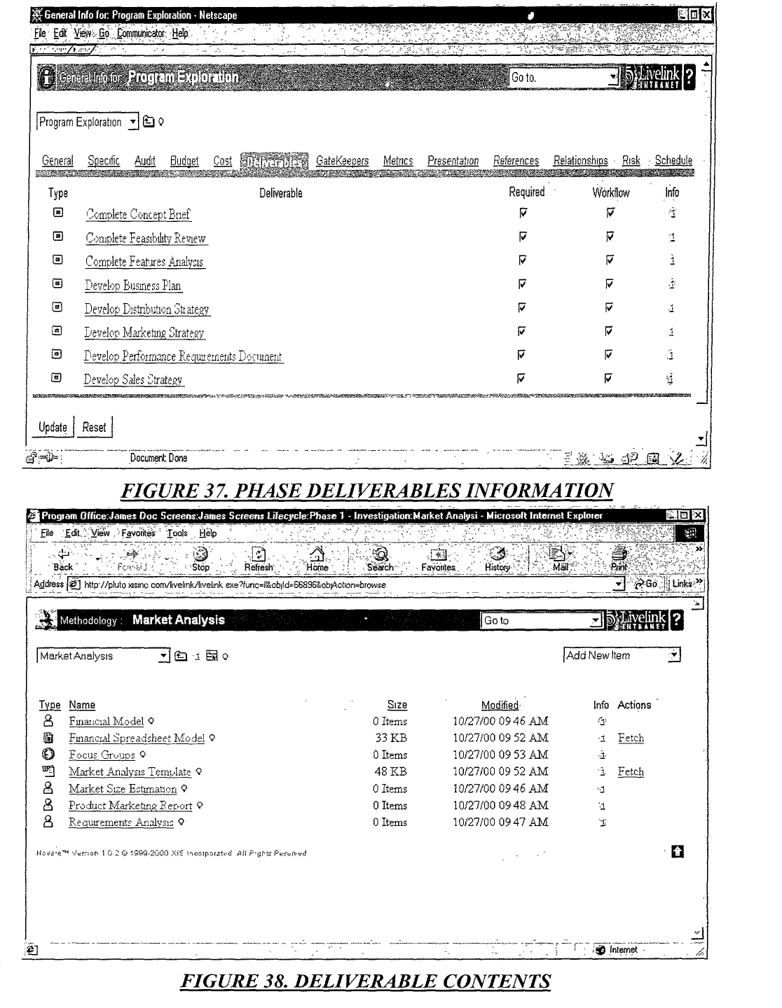

A architect can define which deliverable are required and which ones must be completed using a workflow process in the Phase Deliverables screen. If a Deliverable is Required, it cannot be deleted by a Program Manager during Program or Phase planning. A required Deliverable is also considered an exit criteria for the Phase's Gate Review. On the other hand, if the Deliverable is Optional, the Program Manager can delete it if he or she feels it is not necessary for his Program. When Workflow is Required for a Deliverable, any Workflows within that Deliverable are automatically started when the Deliverable is activated. If Workflow is considered Optional, the Program Manager can opt to manually start any Workflows from the Deliverable-Workflow screen. FIG. 37 is an example graphical interface illustrating Phase Deliverable Information according to specific embodiments of the present invention.

A Deliverable object represents a clearly defined, formal output or work product generally associated with a Phase. FIG. 38 is an example graphical interface illustrating Deliverable Contents according to specific embodiments of the present invention. Various tools such as Workflows, Electronic Forms, and Document Templates are available to complete Deliverables. In addition to these tools, a deliverable can contain Resources, Costs, and Risks.

Defining Relationships Between Deliverables

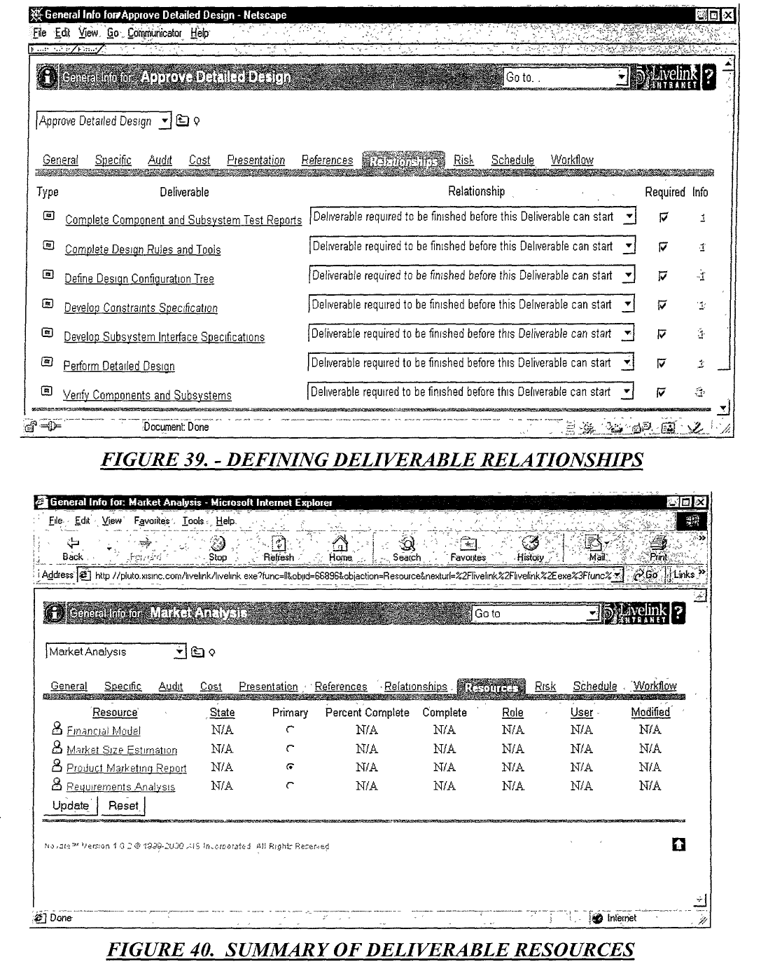

As with Phases, a Relationships screen identifies all relationships between Deliverables, either in the same Phase or in another Phase within the Lifecycle. As with phases, deliverables can have two types of relationships—Finish to Start, and Finish to Finish. An architect can also specify whether these relationships are required or whether they can be tailored by the Program Manager Tailoring allows Program Managers to ensure that the Program plan meets the unique requirements of the Program. When the Required checkbox is selected, the Program Manager cannot edit the relationship. When the Required checkbox is not selected, the Program Manager can edit or remove the relationship. FIG. 39 is an example graphical interface illustrating Defining Deliverable Relationships according to specific embodiments of the present invention. A user can create one or more Resource Assignments in a Deliverable. A summary of Resources associated with the Deliverable can be provided in the Deliverable Resources screen. FIG. 40 is an example graphical interface illustrating Summary Of Deliverable Resources according to specific embodiments of the present invention. When a Deliverable is complete and ready for approval either the Program Manager or the Primary Resource can initiate the approval process. A user can define which Resource is going to act as Primary in the Resource itself or in the parent Deliverable.

Roles for Resource Assignments

When creating a Lifecycle, Resource Assignments are generally associated with Roles. Later, when a Program Manager is tailoring and planning this Lifecycle, the Program Manager will assign users to fulfill these Roles, thereby establishing the Program Team. A list of all Roles is available from a Roles Folder within the Lifecycle itself. Note that if neither a Resource Classification nor Default Rate is defined for the Role, the Resource Classification of the user assigned to the Role on a Program, will be used to define the Role rate.

Defining Resource Assignments

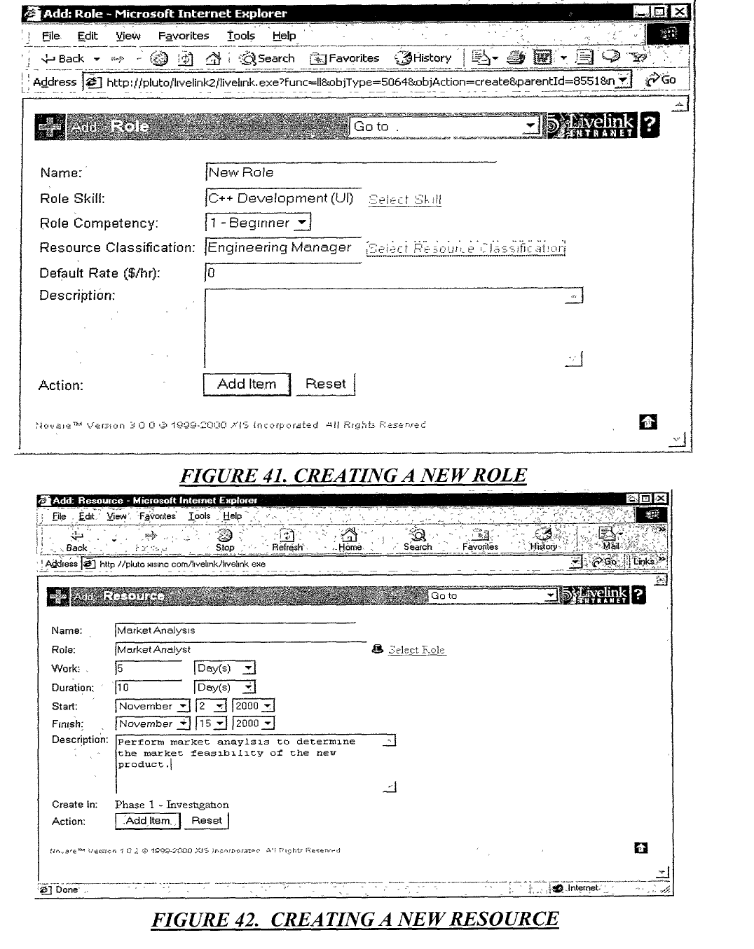

Resource Assignments (or often abbreviated to Resources) capture a discrete amount of work associated with a Lifecycle or Program, Phase, or Deliverable. A user creates Resources within the Lifecycle, Phases, and Deliverables. FIG. 41 is an example graphical interface illustrating Creating a New Role according to specific embodiments of the present invention. As an example, to create a new Resource, a user would do the following:

1. From the Add New Item menu of a Lifecycle, Phase, or Deliverable, select Resource.

2. Enter the Name of the Resource.

3. Select a Role to associate with the Resource.

4. Enter the amount of Work to be performed on the Resource Assignment.

5. Enter the Duration over which the Work will be performed.

6. Enter the Start Date when the Resource Assignment will start (note that in the Methodology Library, all Lifecycle schedules are based on a start date of Jan. 3, 2000).

7. Enter the Finish Date when the Resource Assignment will finish.

8. Enter a Description for the Resource (optional).

9. Press Add Item to create the new Resource.

In a similar way, a user can create a new resource. FIG. 42 is an example graphical interface illustrating Creating a New Resource according to specific embodiments of the present invention.

Defining Fixed Costs

Fixed Costs can be associated with Lifecycles, Phases, and Deliverables. Examples of fixed Costs include equipment Costs, facilities Costs, and consulting fees. In a Lifecycle, these Costs represent expected costs likely to be incurred given past experience with that Lifecycle. Later, when a Program uses the Lifecycle, the Program Manager can delete or modify these Costs as appropriate. A user can create Costs in the Methodology Library using an add object type screen. As an example, to create a new Cost:

1. From the Add New Item menu of a Lifecycle, Phase, or Deliverable, select Cost.

2. Enter a Name for the Cost.

3. Select a Cost Type and Category.

4. Enter an Account name or number (optional).

5. Enter a Purchase Order (PO) number (optional).

6. Enter a Cost Amount (this is the Plan Cost Amount).

7. Enter a Description for the Cost (optional)

8. Press Add Item to create the new Cost.

Defining Expected Risks

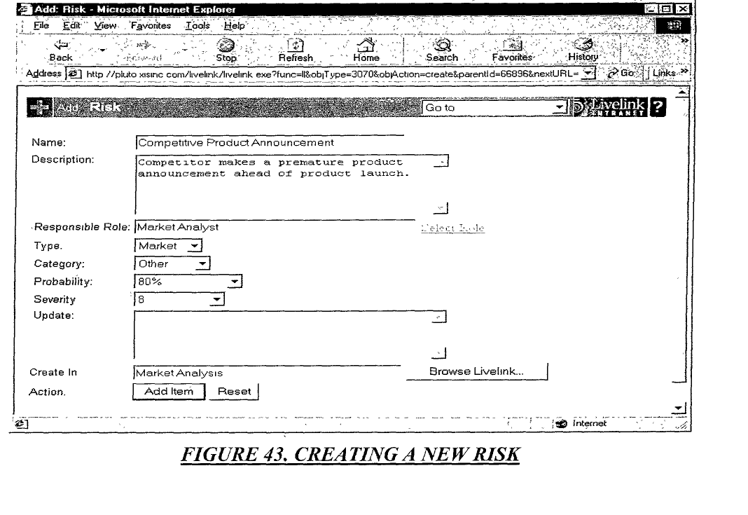

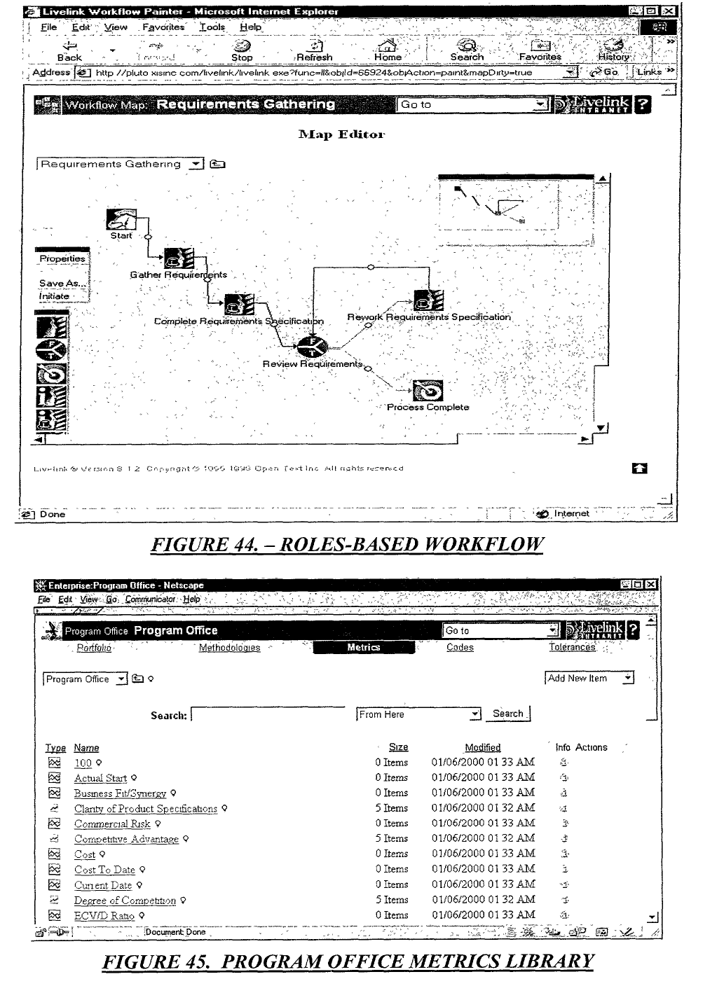

Risks can be associated with Lifecycles, Phases, and Deliverables. In a Lifecycle, these Risks represent expected Risks likely to impact any Program using this Lifecycle. When the Lifecycle is in use on a Program, the Program Manager can delete or modify these Risks as appropriate and as specified in the Lifecycle. FIG. 43 is an example graphical interface illustrating Creating a New Risk according to specific embodiments of the present invention.

Workflows

Workflows are known constructs in other enterprise software packages. According to specific embodiments of the present invention, a user can associate Workilows with a Lifecycle, Phase, or Deliverable object, allowing the architect to define to a low level how processes are performed. In the case of Workflows directly associated with Deliverables, an architect or manager can define whether the use of such Workflows is required or optional In the same way that Resource Assignments are assigned Roles responsible for performing work on the assignment, a user can create Workflows using Roles. Additional Workflow nodes are provided for Initiator (Role), Step (Role), and Form (Role).

When creating a Workflow map, two types of node may be used. First, standard Workflow nodes can be used where steps are assigned to either a user or group. Second, Role steps can be used where steps are assigned to a Role. To assign a Workflow step to a Role:

1. Double-click the Role step to open the User Step Definition screen.

2. In the Search field, select Find to list all Roles associated with the Lifecycle (see FIG. 12.2—Selecting a Role for a Workflow Step).

3. Choose Select for the Role to associate with the Workflow Step.

8. Metrics

Analyzing Program and Portfolio Status

According to specific embodiments, the present invention allows a user to measure Program performance and attractiveness in order to analyze the product Portfolio. In addition to performance measures such as Cost, Schedule, and Risk, Program attractiveness can be measured using Metrics and Factors that are available in the Program Office Metrics Library. FIG. 45 is an example graphical interface illustrating a Program Office Metrics Library according to specific embodiments of the present invention.

Gate Reviews and Metrics

Although Portfolio analysis can be performed at any time, it is typically performed as part of Gate Reviews and Portfolio Reviews. Gate Reviews occur at the end of Phases in a Program Lifecycle and are used to determine whether the Program has met the criteria necessary to pass to the next Phase of the Lifecycle. Metrics and Factors are calculated from the responses of Program team members, GateKeepers, and management to a Questionnaire that polls them on Program characteristics, typically during Gate Reviews. Portfolio Reviews are scheduled events that occur quarterly, semi-annually, or even annually. These events typically coincide with executive strategy reviews assessing progress against business plans.

According to specific embodiments of the present invention, Metrics can be used to compare the attractiveness of Programs in a Portfolio. The invention, in specific embodiments, allows a wide range of Metrics to be defined by a user (typically a Process Architect.), from a simple piece of Program information such as Forecast Finish Date, to a complex subjective assessment of the Program relative to the market (e.g., Probability of Commercial Success). Sample Metrics can be provided during system installation. Metrics can be used to generate multiple views of the development Portfolio that help senior management form a complete picture of the development pipeline. Detailed Metric reports are available at a Program level and Portfolio level. With this understanding, management is empowered to make insightful Program prioritization and budget allocation decisions.

Metric Categories

Metrics are categorized to facilitate structured Portfolio reporting. A user determines the Metric's category when adding it. To view or change the category selected, a user can go to the Specific screen for the Metric. According to specific embodiments of the present invention, there are four categories of Metrics:

| | |
|---|---|
| Risk Metrics | Identify risks that are associated with the development of the |
| | product, such as Technical Risk. |
| Success Metrics | Determine the probability that the product will succeed, such as |
| | Probability of Technical Success. |
| Program Fit Metrics | Determine where a Program fits into the product Portfolio, such as Business |
| | Fit/Synergy and Strategic Fit. |
| Financial Metrics | Determine the value of a product, such as Expected Commercial |
| | Value, Return on Investment (ROI), and Net Present Value (NPV). |

Metric Types

There are five types of Metrics supported according to specific embodiments of the present invention: Factors; Reverse Factors; Equation; Number; and Special. For Factor-based Metrics—the Metric value is computed from associated Factors. The value is computed as the percentage of the total possible value achieved by the responses for the identified Factors. The value for each Factor is normalized to evenly weigh the contribution of the Factors to the Metric's value. For Reverse-Factor Metrics—the Metric value is 100% minus the percentage of the total possible value achieved by the responses for the identified Factors. The Metric represents a concept whose scale is the reverse of the scale of values for the Factors. The value for each Factor is normalized to evenly weigh the contribution of the Factors to the Metric's value. For Number Metrics—the Metric value is entered directly by a User. These Metrics can be Dates, Integers, Dollar (amounts), Real integers, and Percentages. Number Metrics allow for Metrics with complex calculations to be managed outside of the program software system yet still make that Metric value available for comparison with other Metrics within the software system for Portfolio analysis. For Equation Metrics—Metrics value is computed based on two other Metrics. The types of Equation Metrics are Addition (+), Subtraction (−), Multiplication (*), and Division (/). For example, the Overall Probability of Success is the Probability of Technical Success Metric multiplied by the Probability of Commercial Success Metric. For Special Metrics—Metrics value is based on Program attributes such as Plan Start Date and Forecast Cost. Values for these Program performance related Metrics is based on the Program's status at that time.

According to specific embodiments of the present invention, there are two other Special Metrics not directly related to Program information: 100 Metric—allows the calculation of reverse percentages using Equation Metrics. For example, a probability of success is equal to 100 minus the corresponding probability of Risk; Current Date Metric—provides the current date and allows the calculation of such Metrics as Time to Completion. An example of a Metric can be seen in the following Table, Metric Example. The Business Fit/Synergy Metric is used to help determine the alignment between the Program/product and a company's core competencies. It is a Factor-type Metric where seven Factors contribute to the Metric's value.

TABLE 3
METRIC EXAMPLE - BUSINESS FIT/SYNERGY

| | |
|---|---|
| Name | Business Fit/Synergy |
| Description | The Business Fit/Synergy Metric measures how well |
| | the Program/product leverages the business' core |
| | competencies. |
| Type | Factors |
| Category | Program Fit |
| Associated Factors | Process/Manufacturing Technology Maturity |
| | Required manufacturing expertise/experience |
| | Required engineering expertise/experience |
| | Established Customer Base |
| | Experienced Marketing Organization |
| | Established Sales and Distribution Channels |
| | Fit with product Portfolio |

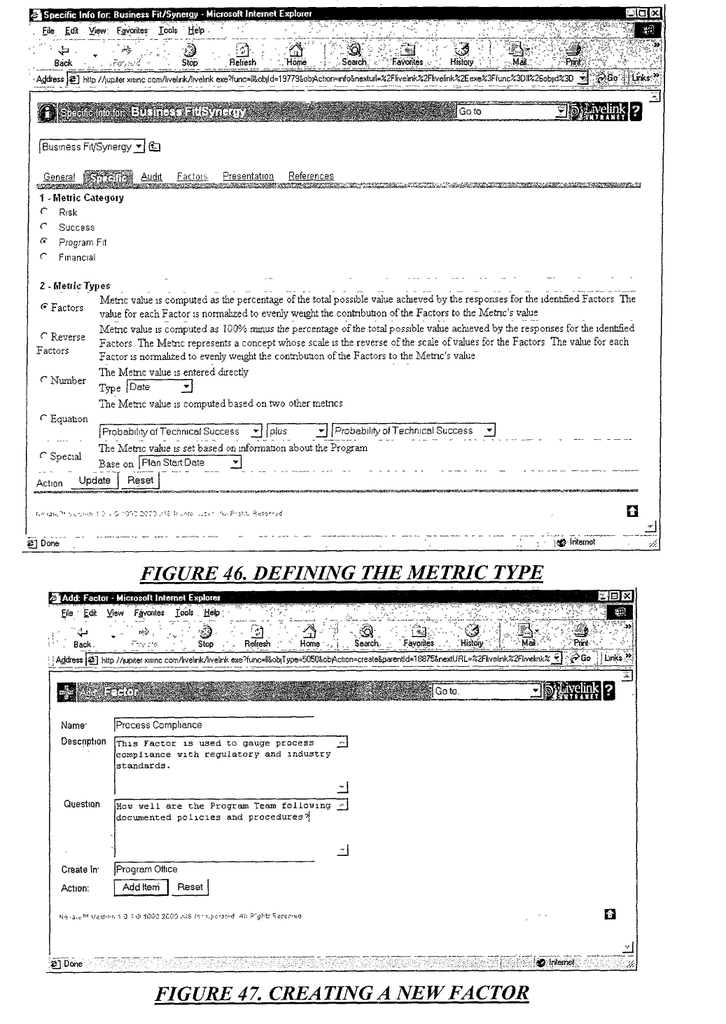

According to specific embodiments of the present invention, a user can both create a Metric and define how it will operate. FIG. 46 is an example graphical interface illustrating Defining a Metrics according to specific embodiments of the present invention. Generally, Metrics have three states—Draft, Complete, and Archive. These states are used to govern the availability of a Metric to Programs. For Metrics of Type Factor or Reverse Factor, Factors are associated with the Metric. As an example, to define how the Metric will function:

1. From the Metric's Info icon, open the Metric-Specific screen.

2. Select the radio button corresponding to the Metric Category to which the new Metric will belong.

3. Select the radio button corresponding to the Metric Type.

3.1 For Metrics of Type Number, select Date, Currency, Percentage, Real, or Integer from the menu of available options.

3.2 For Metrics of Type Equation, select two Metrics to associate through the equation and the nature of the equation (Plus, Minus, Multiplied by, and Divided by).

3.2 For Metrics of Type Special, select the type of Program information that will provide the Metric's value (e.g. Planned Finish Date, Actual Cost, etc.)

4. Press Update to save the change(s).

9. Factors

Defining Metrics using Factors and Questionnaires

According to specific embodiments of the present invention, factors are used to define questions and responses that are then averaged to determine a percent value for a Metric. When a User completes a Questionnaire, the point value for each of the responses to the Factors that make up a Metric are averaged to calculate the final Metric value. Unlike Metrics, Factors do not have states and, once created, can be associated with Metrics.

Factors can be accessed from the Program Office Metrics Library. A user can modify Factors, add new Factors, and edit the relationships between Metrics and Factors. For example, in the Metric for Technical Risk, one of the Factors involved in determining its value is Product Complexity. Each possible measure of product complexity has an assigned point value. Sample Factors can be provided during system installation.

An example of a Factor can be seen in the Table below. Each Factor is composed of a question and an anchored scale that represents the range of possible answers. In this case, the Factor contributes to the values of five different Metrics.

TABLE 4
FACTOR EXAMPLE - DEGREE OF COMPETITION

| | |
|---|---|
| Name | Degree of Competition |
| Description | The Degree of Competition Factor defines the level of competition in the |
| | target market(s) of the new product(s). |
| Question | What is the level of competition in the target market(s)? |
| Scale Anchors | 1 High level of competition, entrenched competitors or price based |
| | competition. |
| 1_2_3_4_5 | 2 |
| | 3 Average level of competition. |
| | 4 |
| | 5 Low level of competition. Barriers to entry for competition are high. |
| Associated | Probability of Commercial Success |
| Metrics | Commercial Risk |
| | Overall Probability of Success |
| | Overall Risk/ |
| | Market Attractiveness |

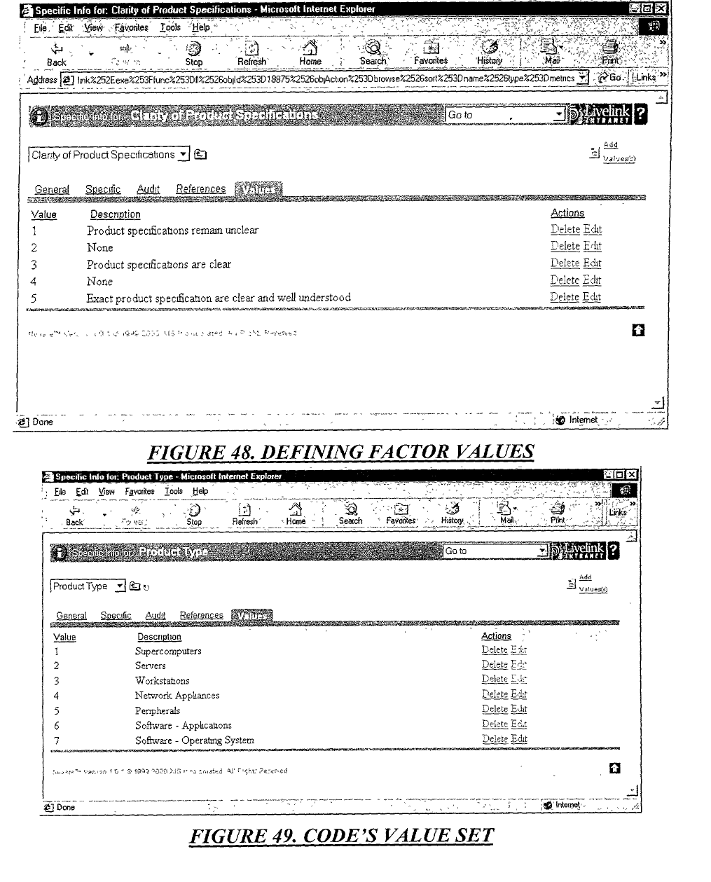

A user creates Factors in the Program Office Metrics and Factors Library. FIG. 47 is an example graphical interface illustrating Creating a Factor according to specific embodiments of the present invention. Once a Factor has been created, you can define the value descriptions for that Factor's scale anchors used in soliciting responses from Questionnaire recipients FIG. 48 is an example graphical interface illustrating Defining Factor Values according to specific embodiments of the present invention.

10. Codes

According to further embodiments of the present invention, Codes can be used to classify Programs and Lifecycles. A user can create and modify Codes from within the Program Office Codes Library. These Codes are referred to as Classification Codes. Sample Classification Codes can be provided during installation. A user can create Codes at any time from within the Codes Library. Examples of Codes include Market Segment, Business Unit, Market Segment, Program Type, and Product Family. Once the Code has been created, the user can define how the Code will be used.

Additionally, a user can create a set of Values for the Code. FIG. 49 is an example graphical interface illustrating Values Sets for Codes according to specific embodiments of the present invention.

Development Engine

According to specific embodiments of the invention, a Development Engine manages all the Schedule, Cost, and Risk information for Lifecycles and their respective Phases, Deliverables, Resources, Costs, and Risks. At any time, Process Architects can see the effects of adding new Methodology Objects to a Lifecycle. For example, extending a Resource's Duration, modifying a Phase relationship, or even adding additional Deliverables. Such information is aggregated from the lowest level (Resources, Costs, and Risks) to the highest level (the company's Program Portfolio).

11. Embodiment in a Networked Programmed Information Appliance

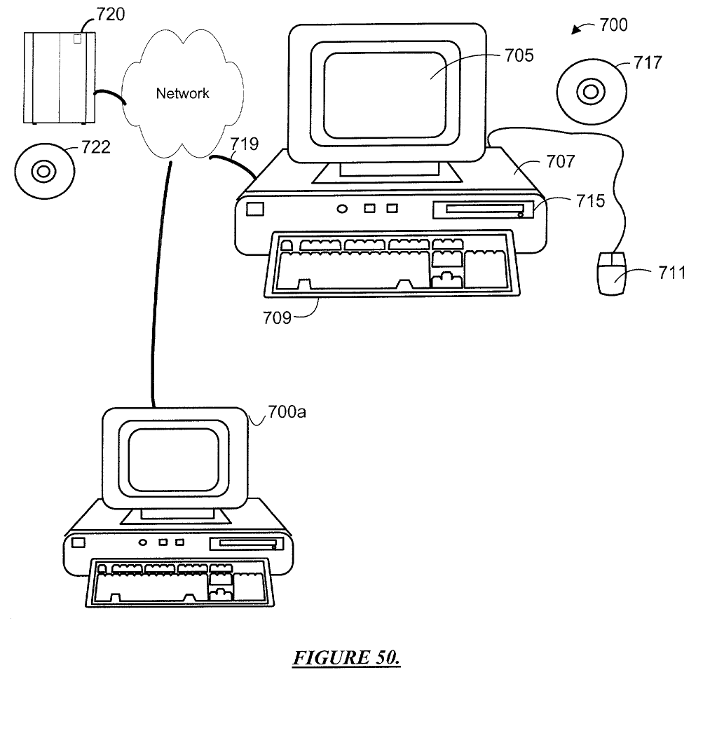

FIG. 50 is a block diagram showing a representative example networked information device and server system in which various aspects of the present invention may be embodied. It will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 50 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. It will be understood to persons skilled in the art that server 720 can comprise one or many computer systems and can perform server functions such as central data storage and generation of graphical interface screens presented on computers such as 700. It will also be understood that many different computer systems such as 700 can be connected via a network to server computer 720. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

What is claimed:

1. A method of designing a process lifecycle using a computer system comprising:
presenting a series of user interfaces allowing a process architect to define a process lifecycle using business model objects as building blocks; and
presenting input indications in said series of user interfaces allowing a process architect to specify what parts of said defined process lifecycle can be deleted or modified; and
wherein said parts of said process lifecycle comprises one or more of said business model objects or one or more relationships between said business model objects.

2. A method of initiating a product development process using a computer system comprising:
presenting one or more user interfaces allowing a program manager to select from one or more defined process lifecycles;
presenting a series of user interfaces allowing a program manager to modified those parts of a selected process lifecycle that are specified as modifiable in said process lifecycle; and
presenting a series of user interfaces allowing a program manager to make assignments to roles in said process lifecycle.

3. A method of executing a product development program using a computer system comprising:
using an instance of a product development process, with one or more predefined roles assigned to one or more process implementers, to coordinate activity of various resources;
presenting one or more user interfaces to one or more process implementers to provide a task list to said one or more process implementers;
presenting one or more user interfaces to one or more process implementers to receive data indicating completed or incompleted tasks from said one or more process implementers;
aggregating data received from said one or more process implementers into project summary data; and
presenting project summary data to a program manager.

4. The method of claim 1 wherein one or more business objects are associated with one or more states that characterize a business object's status.

5. The method of claim 4 wherein business objects when first created have a particular state.

6. The method of claim 4 wherein behavior of a business object depends on one or more business rules.

7. The method of claim 1 wherein business objects can transition between states as a result of changes of state of other business objects in accordance with one or more business rules.

8. The method of claim 7 wherein business rules can be defined during the initial design of a lifecycle or during the modification of a lifecycle for a particular project and can also be imposed by the overall design of the software system.

9. The method of claim 4 wherein business objects can be combined to form a structure or hierarchy where rules associated with a business object are based on one or more factors comprising:
contents of said business object;
business rules of said business object;
relationships of said business object to other business objects;
parent business objects of said business object.

10. The method of claim 4 wherein business objects can be combined to form a structure or hierarchy where rules associated with a business object are based on one or more factors comprising:
contents of said business object such as a gate review business object cannot be complete until all its questionnaires are complete; a project business object cannot be completed until all its phases are complete;
business rules of said business object such as lifecycle applicability rules that determine for which type of program a lifecycle can be used;
relationships of said business object to other business objects such as when a deliverable has a start to finish relationships with another deliverable said deliverable cannot go active until a predecessor deliverable is complete; and
parent business objects of said business object such as a phase is a parent to a deliverable, a lifecycle is a parent to phases, a methodology is a parent to lifecycles and as further examples, a workflow process in a deliverable is automatically initiated when the deliverable becomes active; when a phase is activated, the deliverables it contains are activated depending said deliverables relationships.

11. The method of claim 2 wherein said computer system presents interfaces to a program manager through which said manager:
inputs profile information;
receives and reviews candidate lifecycles;
selects a desired lifecycle;
modifies a selected lifecycle;
creates an instance of a selected and/or modified lifecycle for a particular development program; and
assigns users to predefined roles for said particular development program.

12. The method of claim 1 wherein said business model objects can comprise one or more of: methodology, lifecycle, role, phase, deliverable, resource assignment, fixed cost, and risk.

13. A computer system software engine usable for designing process lifecycles and managing and executing instances of process lifecycles for particular projects comprising: one or more methodologies;
wherein each of said methodologies comprises one or more similar lifecycles;
wherein each of said lifecycles comprises one or more phases; and
wherein each of said phases can comprise one or more deliverables.

14. The system of claim 13 further comprising:
wherein each of said lifecycles can comprise one or more of role, cost, resource, and risk data.

15. The system of claim 13 further comprising:
wherein each of said phases can comprise one or more of role, cost, resource, and risk data.

16. The system of claim 13 further comprising:
wherein each of said deliverables can comprise one or more of role, cost, resource, and risk data and one or more workflows, templates, and forms.

17. The method of claim 1 wherein said states can comprise one or more of: pending, planning, active, complete, inactive, canceled; and additional states.

18. The method of claim 1 wherein object state transitions can be manual or automatic.

19. The method of claim 1 wherein automatic object state transitions occur based on similar transitions of other related objects.

20. The method of claim 1 wherein an object state transition can cause other cascading object state transitions that thereby automate aspects of the development process.

21. The method of claim 1:
wherein a resource assignment object can be initialized to be activated just-in-time, e.g., only after all predecessors are complete;
wherein activation of a resource assignment object triggers one or more task notifications; and further comprising:
automatically notifying a process implementer using said computer system of a task in response to said activated resource assignment object.

22. A method of managing a product development process using a computer system comprising:
defining elements of a process lifecycle in a structured hierarchy of phases and deliverables;
wherein once said structured hierarchy of phases and deliverables is specified, said computer system is capable of enforcing required aspects of said process lifecycle;
wherein once said structured hierarchy of phases and deliverables is specified said computer system automates execution of a program by distributing assignments as they are needed and providing a continuously updated living schedule integrating progress status of all aspects of a program;
defining states associated with phases and deliverables that characterize their status;
after said defining, providing access to one or more process managers to input initial information regarding phases and deliverables including relationships and dependencies between phases and deliverables and state goals for phases and deliverables;
providing access to said computer system to one or more process implementers in order for said implementers to enter data indicating changing status of phases/deliverables;
in accordance with said defined process/lifecycle phases and deliverables, informing one or more process implementers of updated lifecycle resource needs and due dates;
in response to a request from a manager, providing overview and drill-down reports of updated process/lifecycle status.

23. The method of claim 22 wherein said elements of a process/lifecycle comprise schedules, tasks, relationships, documents and resource requirements.

24. The method of claim 22 wherein said elements of a process/lifecycle comprise hourly cost, required skills, and competency levels.

25. The method of claim 22 further comprising:
allowing a process architect to indicate what parts of the process/lifecycle are mandatory and what parts (where parts comprise objects, their relationships and the lifecycle itself) can be can be changed by a program manager or team in order to enforce process parameters.

26. The method of claim 22 further comprising:
allowing a process architect to classify a lifecycle based on a series of user-defined criteria that will determine the conditions under which the lifecycle can be used, wherein said user-defined criteria can comprise one or more of:
the type of product being developed;
the market to which the product will be sold; and
a business unit for which the product is intended.

27. The method of claim 26 further comprising assisting a program manager in selecting the most appropriate lifecycles for a development program.

28. The method of claim 22 further comprising:
allowing a program manager to indicate other users that will part of a program by assigning individuals to roles specified in a program lifecycle;
creating an association between roles or users and and program tasks and
thereby supporting automated execution (putting things on user tasks list, communicating with users, etc.) when the program is activated.

29. The method of claim 28 further comprising:
sending tasks to a user's personal task lists when said tasks are needed, based on approvals and the progress of work on related tasks or groups of tasks.

30. The method of claim 29 wherein a task sent to users may have linked to them documents or other information needed to complete said task.

31. The method of claim 28 further comprising:
providing one or more users (both process implementators and project managers) with real time/living schedule reports that reflect the latest updates and revisions.

32. The method of claim 31 further wherein said updates and revisions comprise revisions made by users to their tasks via a communication channel.

33. The method of claim 31 further comprising:
wherein said updates and revisions comprise addition or removal of tasks or groups of tasks from the overall process via a communication channel.

34. The method of claim 22 further comprising:
enforcing a consistent process structure/hierarchy (lifecycle, phase, deliverable, resource);
enforcing a consistent mapping of organizational structure (divisions, business units);
consolidating schedule, cost, risk and resource information; and
providing a user with a requested report at any requested level in the process hierarchy and for any requested part of the company.

35. The method of claim 22 further comprising:
comparing real time forecast data from individual users to plan values for schedule and costs;
changing the state of an indicator when user defined tolerances are exceeded; and
notifying users of impending schedule slips or cost overruns.

36. The method of claim 35 further wherein notification of a slip in a schedule is escalated to higher level reports in the process hierarchy only when said slip occurs on a schedule critical path, thereby making potential schedule delays along the critical path visible in the highest level reports.

37. The method of claim 36 further comprising allowing a user to view an alert of a slip in a higher level report and allowing the user to drill down to more detailed, lower level reports to get to the source of said slip.

38. A method of evaluating and comparing a group of product development programs in a portfolio using a computer system comprising:
allowing a user to define program-specific metrics that will be tracked by said computer system;
allowing a user to define how metric values will be obtained during execution of a program; and
presenting to a user multi-program portfolio data regarding multiple programs' phase, cost, schedule, and risk status.

39. The method of claim 38 further wherein said metrics can be derived from system data (e.g. cost to date).

40. The method of claim 38 further wherein said metrics can be derived from user input during reviews (e.g. sales forecasts).

41. The method of claim 38 further wherein said metrics can be derived from quantitative responses to one or more questions

42. The method of claim 38 further wherein said metrics can be derived from a user-defined mathematical formula involving one or more other metrics (e.g. metric 1 divided by metric 2).

43. The method of claim 41 further comprising:
for metrics derived from questionnaire responses, allowing a user to define the questions to be associated with the metric; and
for metrics derived from questionnaire responses, allowing a user to define a questions response scale.

44. The method of claim 41 further comprising:
allowing a user to specify which users will receive an electronic questionnaire that will be used to capture responses.

45. The method of claim 41 further comprising:
allowing users to analyze and discuss user responses, and to enter a consensus score to be used in calculating metric values for program and multi-program analysis.

46. The method of claim 38 further comprising providing users with metric reports to support program review and portfolio level decision making, said metric reports derived from one or more of:
system data;
user input during reviews;
quantitative responses to one or more questions;
user define mathematical formula involving one or more other metrics.

47. The method of claim 38 further comprising:
allowing users to compare program attractiveness and performance by creating customized tabular reports and charts of the programs and metrics they wish to analyze.

48. A network-based method for automating requesting and assigning resources to work on projects comprising:
allowing a user to search for available resources/users with the skill and competency level required to accomplish tasks on a development project with a single action;
returning to a user a list of resources/users;
including in said returned list an analysis of how a proposed assignment will impact overall utilization of indicated resources;
including in said returned list an analysis of how well the resources are able to satisfy the demands of the assignment;
allowing the user to request a single user or group of users from one or more users acting as resource managers, via the web;
routing a request to the appropriate users acting as functional managers for review;
providing reports that show the detailed impact of the assignment on the requested user(s) and allows the user acting as the functional manager to approve, reject, or propose an alternative user; and
routing the functional managers decision back to the requesting user for review, who can accept the decision or make another resource request, wherein accepting the decisions automatically assigns the user in question to the program and gives the assigned user him access to the web based program workspace.
